(19) United States
(12) Patent Application Publication
(10) Pub. No.: US 2025/0291692 A1
(43) Pub. Date: Sep. 18, 2025

(54) Distributed Multi-Client Control Of Performance Telemetry Subsystem In A Multi-Die Chip

(71) Applicant: NVIDIA Corporation, Santa Clara, CA (US)

(72) Inventors: Pranav VAIDYA, San Jose, CA (US); Shounak KAMALAPURKAR, San Jose, CA (US); Gregory SMITH, Leander, TX (US); Abhijat Manohar RANADE, Austin, TX (US); Thomas OGLETREE, Bee Cave, TX (US); Timothy J. MCDONALD, Austin, TX (US); Alan MENEZES, Webster Groves, MO (US); Aditya JOSHI, Newark, CA (US); Madhumitha RAMACHANDRAN, Austin, TX (US); Igor ISSAKOV, Austin, TX (US)

(21) Appl. No.: 18/747,404

(22) Filed: Jun. 18, 2024

Related U.S. Application Data
(60) Provisional application No. 63/566,370, filed on Mar. 17, 2024.

(51) Int. Cl. H04L 45/00; H04L 45/74; H04L 45/745

(52) U.S. Cl. CPC G06F 11/3024

(57) ABSTRACT

Computing system performance monitors provide on-chip control, selection, collection, coalescing and communication of behavior and other processing-indicating data of high performance single- and multi-die computing and processing systems, such as for use in multi-chip-module and/or multi-instanced graphics processing units (GPUs) and/or systems-on-chips (SOCs). Commands and data records can be forwarded between modules to abstract the processing system from profilers and other data report consumers. Quality of Service and security isolation for different command and data report streams is maintained.

### CROSS-REFERENCE TO RELATED APPLICATIONS

Benefit is claimed from U.S. provisional patent application No. 63/566,370 filed Mar. 17, 2024. This application is related to copending commonly-assigned application Ser. No. 18/747,398 entitled “Collection And Forwarding Of Distributed Performance Telemetry Data In A Multi-Die Chip” filed on date even herewith under attorney docket no. 6610-163. Each of these applications is incorporated by reference herein.

### FIELD

This technology relates to computing system performance monitoring, and more particularly to on-chip control, selection, collection, coalescing and communication of metrics, measurements, and related attribution metadata from high performance single- and multi-die computing and processing systems, such as for use in multi-chip-module and/or multi-instanced graphics processing units (GPUs) and/or systems-on-chips (SOCs).

### BACKGROUND

### Miniaturization Rate is Slowing

Integrated circuits are made by imaging microcircuit patterns onto a semiconductor wafer. The patterned images are replicated onto many individual rectangular areas of the wafer called “dies”—thumbnail sized rectangles of semiconductor material on which transistors and other circuitry are fabricated. See FIG. 1. Manufacturing processes are used to convert the patterned images into microcircuits. The wafer is then cut up into the individual dies for packaging as integrated circuit “chips”. The more microcircuitry that can be packed onto a die, the more functionality each die can provide.

Intel's Gordon Moore predicted in 1965 that the number of transistors on an integrated circuit would double every two years with minimal rise in cost. Mr. Moore's prediction largely held true for many years, but the rate of miniaturization has been slowing over the past decade due to practical limitations in semiconductor chip manufacturing. Yet, the need for higher and higher performing processing systems continues to exist in many domains. As the number of transistors per die no longer grows at historical rates, the performance curve of monolithic high performance processing systems will ultimately plateau. The time has come when there may not be enough room on a single die to fit all the desired increased functionality. These factors have led some industry leaders to proclaim that the ability for Moore's Law to deliver twice the performance at the same cost, or at the same performance, half the cost, every year and a half, is over. See e.g., comments of NVIDIA's Jensen Huang reported at “Jensen Huang says Moore's law is dead. Not quite yet” The Economist (12/13/23), economist.com/science-and-technology/2023/12/13/jensen-huang-says-moores-law-is-dead-not-quite-yet

### Multi-Chip Module Processing Systems

To address this need, some in the semiconductor industry have proposed to make each “chip” out of multiple chip modules (“MCM”s)—i.e., package-level integration of multiple die modules to build larger logical processing systems that can enable continuous performance scaling beyond Moore's law. For example, it has been proposed to partition GPUs into easily manufacturable more basic GPU Modules (“GPMs”) each on its own dielet, and integrate multiple dielets on package using high bandwidth, power efficient signaling technologies. See for example Arunkumar et al, MCM-GPU: Multi-Chip-Module GPUs for Continued Performance Scalability, International Symposium on Computer Architecture (ISCA) (ACM 2017), research.nvidia.com/publication/2017-06_mcm-gpu-multi-chip-module-gpus-continued-performance-scalability, /doi.org/http://dx.doi.org/10.1145/3079856.3080231; “TSMC's New Wafer-on-Wafer Process to Empower NVIDIA and AMD GPU Designs,” engineeering.com (May 3, 2018), engineering.com/story/tsmcs-new-wafer-on-wafer-process-to-empower-nvidia-and-amd-gpu-designs.

Such an approach such as shown in prior art FIGS. 2A & 2B for an example graphics processing unit (“GPU”) implements the MCM-GPU as a collection of GPMs that share resources and are presented to software and programmers as a single monolithic (meaning single die), integrated unitary high performance processing system. The multi-chip modules may either be replicated (identical) or specialized depending on the demands of custom functionality, process technology, area, and/or power requirements. The multi-chip modules are connected together by wires in a common integrated circuit package (e.g., by stacking in one implementation see FIGS. 13A, 13B) to operate together as a unitary overall processing system. Such an approach can enable resource sharing of underutilized structures within a single processing system and eliminate hardware replication that would be needed if each die contained its own fully independent processing system.

As noted above, it is desirable to isolate the operating system and application developers from the fact that a single logical processing system may now consist of processing engines and other resources distributed across different modules that are working together. Applications should be able to transparently leverage bigger and more capable processing systems, without any additional programming effort. See Arunkumar et al. But as detailed below, such promises are not without their challenges.

### Virtualized High Performance Processing Systems for Cloud Computing

Meanwhile, a different innovation related to the cloud has driven use of sophisticated techniques to dynamically, securely divide up and “virtualize” functionality of a high performance processing system into multiple virtualized (as opposed to physical) fractional processing systems that can be dynamically allocated for use by different users or “tenants”. The term “tenant” is often used because just like in an apartment building, the tenant user is temporarily assigned their own dedicated resources in a larger system. Different tenants can be assigned different resources, with each tenant having full access to their own assigned resources but no access to resources assigned to another tenant. Quality of Service (QoS) is maintained for each tenant so one tenant is not unfairly benefitted over or adversely affected by another.

Along these lines, NVIDIA has released a Multi-Instance GPU (“MIG”) feature that allows a GPU to be securely partitioned into a number of separate GPU virtual instances, providing each of multiple tenants with their own dedicated GPU resources. MIG enables multiple GPU Instances to run in parallel on a single, physical GPU. See e.g., NVIDIA Multi-Instance GPU User Guide, docs.nvidia.com/datacenter/tesla/mig-user-guide/index.html (11/17/2022); US20230288471. To a GPU application, the instance it is running on “looks” like a complete GPU even though the instance is actually a fractional, virtualized part of the underlying GPU hardware. This feature is particularly beneficial for workloads that do not fully saturate the GPU's compute capacity since they enable different tenants to run different workloads in parallel to maximize utilization of the GPU hardware.

MIG ensures one tenant cannot impact the work or scheduling of other tenants, in addition to providing enhanced isolation for security purposes as prior art FIG. 3 illustrates, with MIG, each instance's processors have separate and isolated paths through the entire memory system—the on-chip crossbar ports, L2 cache banks, memory controllers, and DRAM address busses are all assigned uniquely to an individual instance. This ensures that one tenant's workload can run with predictable throughput and experience predicable latencies, with the same L2 cache allocation and DRAM bandwidth, while another tenant's tasks are thrashing their own caches or saturating their DRAM interfaces. MIG can partition available GPU compute resources (including “GPC” clusters of processing cores such as streaming multiprocessors (“SMs) and other GPU engines such as copy engines or decoders), to provide a defined quality of service (QoS), with fault isolation for different applications such as virtual machines (VMs), containers or processes—so that one faulted process does not take down other processes.

### On-Chip Performance Monitoring

When engineers want to know how a system is performing in detail, they often build sensors into the system itself to measure system performance metrics. For example, the car you drive has a sensor that measures how the car's engine burns fuel and lets you know when something is wrong (or if an electric vehicle, how efficiently the batteries charge and discharge). Your household thermostat may monitor heating efficiency and send you an alert letting you know when energy usage is unusually high. Your home alarm system might even alert you if your washing machine starts leaking or your refrigerator stops cooling.

The same is true of complex computer processing systems such as central processing units (CPUs) and graphics processing units (GPUs). These high performance computing systems provide many different kinds of functionality including for example storage/memory, instruction/data fetch, arithmetic processing, graphics processing, synchronization, communication, power management, and much more. It is desirable to monitor the performance of such complex processing systems from the inside out—not only externally from the standpoint of power utilization, heat generation and the like, but also dynamically while the processing system executes applications. Such solutions are sometimes referred to as “telemetry” because they make use of communications pathways in a way that offers little or no interference to data, memory and processing flows the processing system uses to run and process applications and thus may be (but do not need to be) “always on.” See e.g., docs.nvidia.com/networking/display/ufmenterpriseumv61325/telemetry.

Such on-chip performance monitoring for example may be controlled to generate performance metrics in the form of counts such as, for example, the number of bytes of data processed or the number of instructions executed in a specified time frame. The counts are saved or read, and then reset using trigger signals. As shown in FIGS. 6A, 6B, -6C, such collected metrics can be used to determine how well the processing system is performing particular work, how efficiently a particular application or portions thereof is running on the processing system, and for other reasons. See e.g., U.S. Ser. No. 11/687,435; U.S. Ser. No. 11/144,087; US 20140012532; US 20140229754; U.S. Ser. No. 10/668,386; U.S. Ser. No. 11/106,261; U.S. Ser. No. 11/880,261; U.S. Pat. Nos. 8,436,870; 8,019,978; US 20140168231; US20230297485; Zhou et al, “GPA: A GPU Performance Advisor Based on Instruction Sampling,” 2021 IEEE/ACM International Symposium on Code Generation and Optimization (CGO), Seoul, Korea (South), 2021, pp. 115-125, doi: 10.1109/CG051591.2021.9370339 & youtu.be/KiURZcr3TwY?si=HCH-BwJEXkE439Yx; Chimeh, “What the Profiler is Telling You” (NVIDIA September 2020), youtu.be/kKANPOkL_hk?si=v_Om9-crR1oxaE5b; developer.nvidia.com/nsight-systems; developer.nvidia.com/blog/nvidia-announces-nsight-graphics-2020-5/; nvidia.com/en-us/data-center/base-command-platform/.

As a non-limiting example, NVIDIA's profiling and performance monitoring tools expose thousands of selectable measurable performance metrics to the programmer/developer to enable them to maximize their CUDA® (“Compute Unified Architecture”) GPU application's performance on NVIDIA GPU hardware. Such performance metrics can for example be communicated to an external “consumer” monitoring device for use by a developer to “profile” a GPU application to see whether it is using GPU resources efficiently, provide insight on how to modify the GPU application to make the GPU application more efficient for target hardware, and visualize dynamic GPU performance and behavior. See e.g., Profiler User's Guide docs.nvidia.com/cuda/profiler-users-guide/index.html (2023).

As shown in prior art FIGS. 3 and 3A NVIDIA's previous generation GPUs supported simultaneous performance monitoring “telemetry” for each GPU instance. For example, FIG. 3A shows a prior art single-tenant, single-profiler baseline design. It consists of on-chip telemetry Data Generators (“DGs”) as described for example in US20230297485 that capture signals or events of interest from engines and other hardware resources. These signals are captured programmatically (for example, with range-based profiling where profiled workload is wrapped with performance capture commands) and/or periodically (for example, with temporal profiling where telemetry signals are periodically sampled). The DGs package these telemetry signals into data records on each sample and send them to an on-chip Performance Monitor Aggregator (PMA).

The PMA in such prior designs contained a “Channel” comprising one bind point and one buffer instance.

As shown in FIG. 3B, a PMA “Channel” in such prior designs consisted of a single Bind Point Controller (BPC) that defined the Virtual Address (VA) space of a given tenant through address space identifiers like memory management unit engine IDs (MMU EIDs). Each PMA Channel also defined a single buffer for streaming data generator records to memory. The Channel was replicated K times, one for each tenant. When the PMA Channel receives the telemetry records from a DG, it writes the records to its associated buffer as the Channel defines. Different PMA Channels manage their own independent-buffers, so that different tenants could have respective concurrent monitoring sessions, with each tenant session monitoring types of performance parameters over different start and stop times specified by that respective tenant.

### Challenges

As high performance processing systems—especially but not only those that span across multiple dies in a MCM design—become increasingly complex, challenges have arisen concerning how to efficiently and effectively provide static and dynamic performance monitoring and control without requiring monitoring and interfacing consumers to be “aware” of underlying hardware complexity. It is also desirable to provide plural simultaneous streams for each tenant or monitoring session while keeping the cost of doing so low. It is also desirable to avoid quality of service (QoS) degradations and maintain security. In particular, certain previously developed solutions appear to have certain limitations such as:
a) independent and fully partitioned telemetry collection per die which hence cannot identify profiling region overlap between engines present in multiple dies, and/or
b) inability to control the telemetry hardware across multiple dies in concert, and/or
c) supported only a restricted number of consumers, often at the device level where the tenant is required to own the entire GPU in order to gather telemetry, and/or
d) each MIG tenant could have only a single performance monitoring stream.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows prior art semiconductor dies on a semiconductor wafer.

FIG. 2A is a prior art conceptual diagram of a multi-die (multi-chip module) processing system implementation.

FIG. 2B is a prior art block diagram of a multi-chip-module graphics processing unit.

FIG. 3 is a prior art conceptual diagram of a multi-instance graphics processing unit (“MIG”).

FIG. 3A shows a prior art single-tenant single consumer application performance monitoring telemetry system.

FIG. 3B shows a prior art PMA Channel.

FIG. 4 is a block schematic diagram of a multi-die GPU in accordance with example non-limiting embodiments herein.

FIG. 4A is a block schematic diagram of a multi-die GPU in accordance with example non-limiting embodiments herein where both or all dies (or more than one die) each stream performance data.

FIG. 4B is a block schematic diagram of example non-limiting embodiments herein where the GPU securely provides separate performance data streaming sessions to different consumers of the same tenant.

FIG. 4C is a block schematic diagram of example non-limiting embodiments herein where the GPU securely provides separate performance data to different tenants, and streaming sessions to different consumers of the same tenant.

FIG. 4D illustrates example simultaneous multiple sessions for multiple MIG tenants.

FIGS. 5 & 5A show an example non-limiting data generator.

FIGS. 6A-6C are color illustrations showing example profiler displays produced based on data from such GPU data generators.

FIG. 7 is a simplified block diagram of example components with the GPU used for data generation, collection, and routing.

FIG. 7A is schematic illustration of how the components shown in FIG. 7 may be distributed across multiple dies of a multi-die GPU processing system.

FIG. 8A shows an example distributed multi-die GPU architecture.

FIG. 8B shows example on-die communication within the FIG. 8A architecture.

FIG. 8C shows example cross-die communication within the FIG. 8A architecture.

FIGS. 9A, 9B show example data generator capture modes defining temporal regions of interest.

FIG. 10 shows an example multi-die GPU architecture including cross-die command packet communication.

FIG. 11 shows an example cross-die forward control path arrangement.

FIG. 12 shows a multi-die GPU command architecture using multiple control paths and multiple forward control paths.

FIG. 13 shows example data record routing from data generators distributed across multiple dies to a common (e.g., user or tenant-assigned) virtual memory address space.

FIGS. 13A, 13B show example data record routing in different types of multi-die packages.

FIG. 14 is a block diagram of an example Performance Monitor Aggregator (PMA) channelized Channel Block arrangement.

FIG. 14A illustrates transmission according to a Channel Block of plural independent streaming channels into respective memory buffers within a virtual memory address space defined by a bind point.

FIG. 15 shows example data record routing components and communications paths in a multi-die GPU processing system.

FIGS. 16A-16F are together a flip chart animation of how data records can be routed cross die in the FIG. 15 processing system.

FIG. 17 shows example data routing channel designator mapping.

FIG. 17A shows an example PMA Device Routing Table (PDRT)

FIG. 18 shows example separate credit loops within the FIG. 15 example data record routing components and communications paths in a multi-die GPU processing system.

FIGS. 19A-19T are together a flip chart animation showing example propagation of channel association information across a data path.

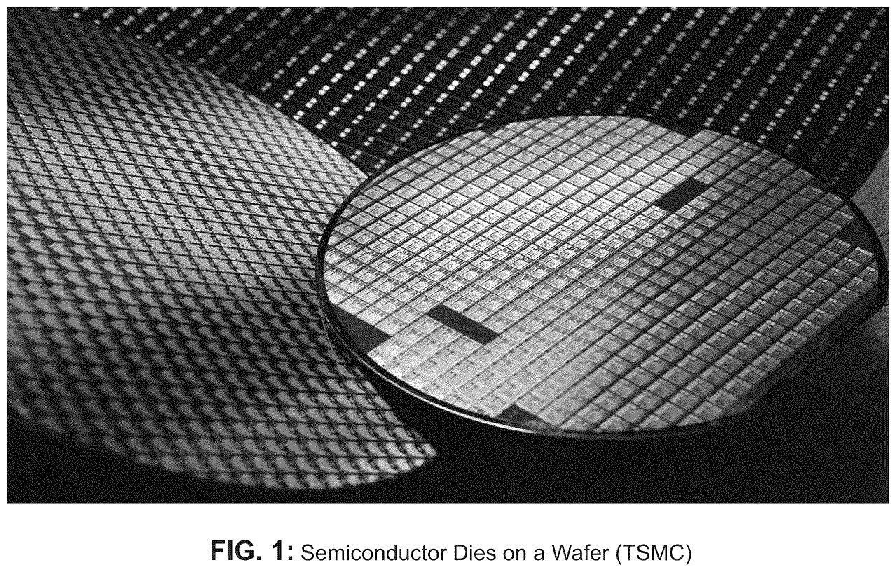

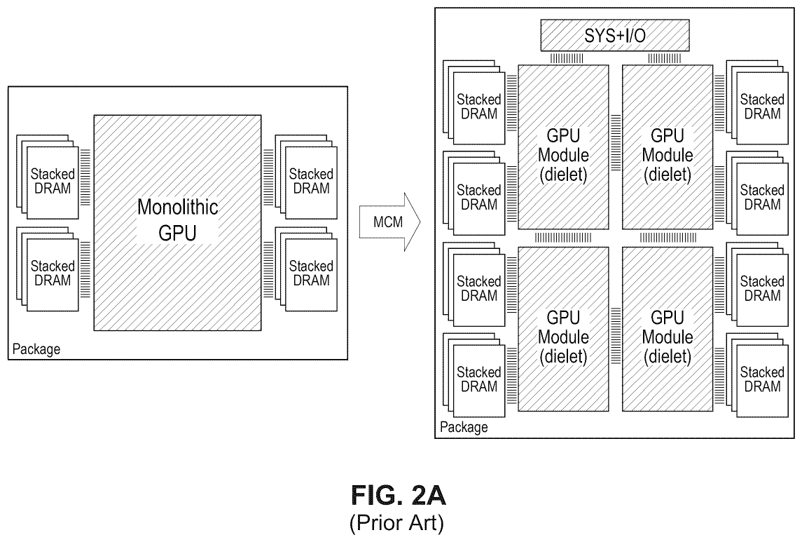

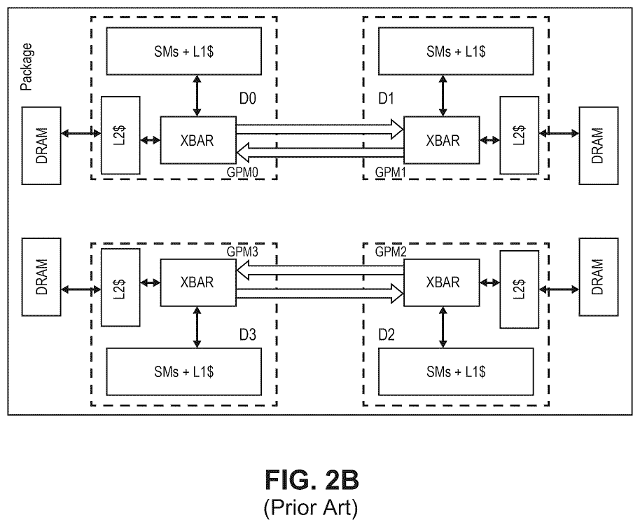

### DETAILED DESCRIPTION OF EXAMPLE NON-LIMITING EMBODIMENTS

The example technology provides an extensible, flexible, and customizable performance telemetry system for multi die processor chips (e.g., either multi-die GPUs and other processing systems or in the future multi-die integrated GPU/CPU chips) that provides non-limiting features and advantages including the following provided by example embodiments:

Abstracts multi-die nature of chip from telemetry tools by facilitating a centralized mechanism to control performance telemetry hardware distributed across multiple dies. This further enables a comprehensive set of control and data collection scenarios for such telemetry hardware across multiple dies. For example, it enables a) temporal profiling where continuous capture of time-based observation windows is done across multiple dies, and/or b) management of telemetry hardware to reset telemetry components or to pause the collection of telemetry data across multiple dies.

Supports multiple telemetry consumer applications simultaneously on a virtualized GPU where each consumer application may be monitoring a subset of resources that can span across multiple dielets and where information gathered for one user/tenant can be protected from being shared with another user/tenant (e.g., for multi-tenant scenarios such as MIG).

Supports numerous combinations of telemetry applications running concurrently while observing their own fractional resources (no restriction on the number of applications that can be supported).

Accepts profiling observation window start/stop messages from multiple engines that may be spread across distinct dielets in multi-chip module implementations.

A distributed telemetry record collection system where telemetry records from multiple dies can be collected and/or forwarded to an extended “Channel Block” {CBLOCK, CHANNEL} from any die. This reduces memory management overhead in both hardware and software as the number of dies scale. There is no need for example to fully partition the telemetry record collection per-die and potentially per-tenant or other division, which would increase software overhead, hardware memory management overhead, or restrict the number of concurrent data collection sessions supported in the system to meet non-interference goals.

Forwarding of collected telemetry records in a multi-die chip between system-on-a-chip (SOC, CPU) and GPUs.

Supports on-chip hardware aggregation of a wide variety of performance metrics for low bandwidth telemetry. There is no requirement to collect information per-die and summarize these metrics in software, which may restrict the number of metrics collected in the system to meet low-bandwidth requirements.

Facilitates the tenant resources to be present in multiple dies, provides quality of service (QoS) for both local-die and remote-die telemetry record collection, and imposes minimal area and power requirements in a multi-die chip, thereby avoiding any limitations on collection sessions and/or metrics collected across all dies.

Scalable of the 2.5D vs 3D scaling used in multi-die chips, uses limited hardware resources, is customizable to different multi-die chip architectures, and interferes at no more than an extremely minimal rate with functional traffic that is being transmitted on any shared interconnects.

Minimizes consumption of memory bandwidth, power, and die area in meeting the above requirements.

As noted above, example embodiments:

(A) provide a way to support multiple telemetry sessions per tenant, in a multi-user, shared GPU (Graphical Processing Unit) environment, and

(B) provide an extensible, flexible, and secure, multi-user performance telemetry system that abstracts away the multi-die nature of the chip from profiling tools.

Example embodiments thus collect telemetry and performance signals from different dies, for multiple users and/or monitoring sessions, each running their own set of tools with differing observation, QoS, and/or security requirements, while isolating consumers from the complexity of multi-die data collection.

Example non-limiting embodiments herein scale as per multiple dies, consumers, and tenant requirements put forth in any given architecture, thus providing more efficient area, bandwidth, and power requirements to manage telemetry hardware and performance monitoring collection and command processes across multiple dies.

### Example Processing System

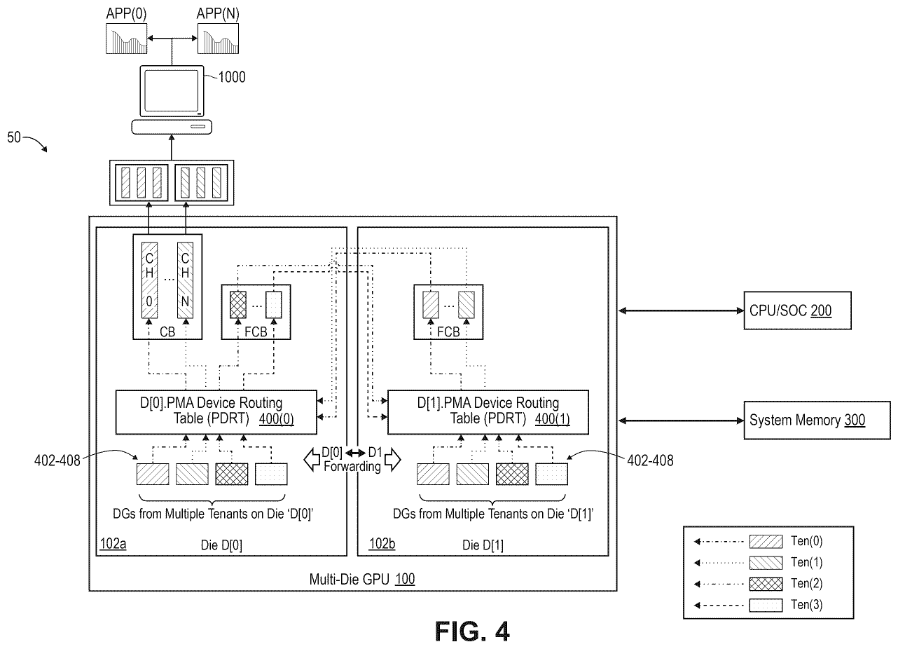

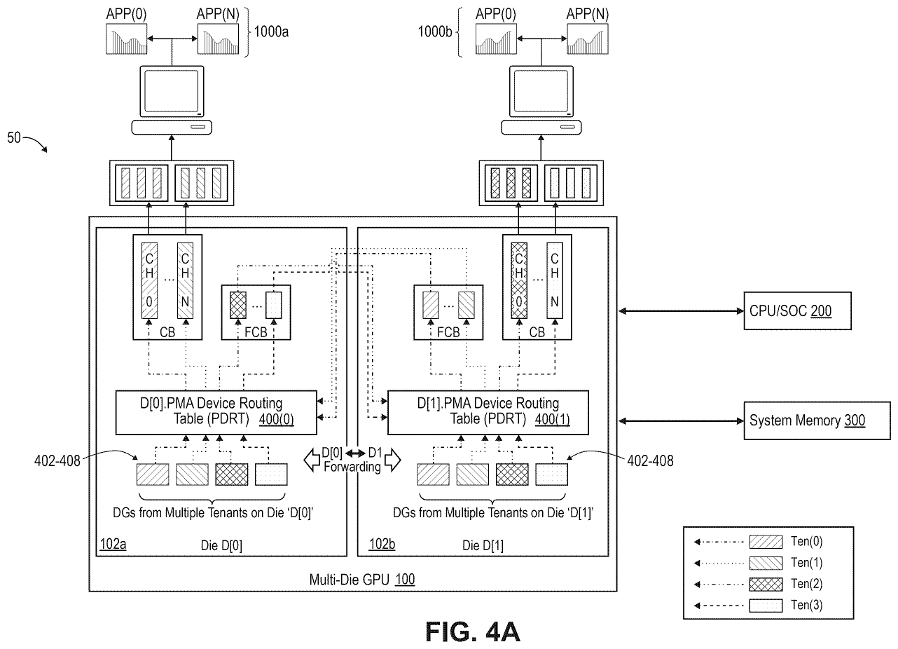

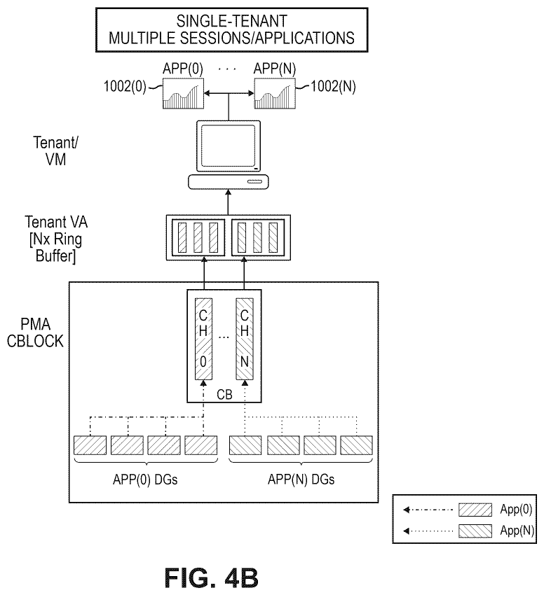

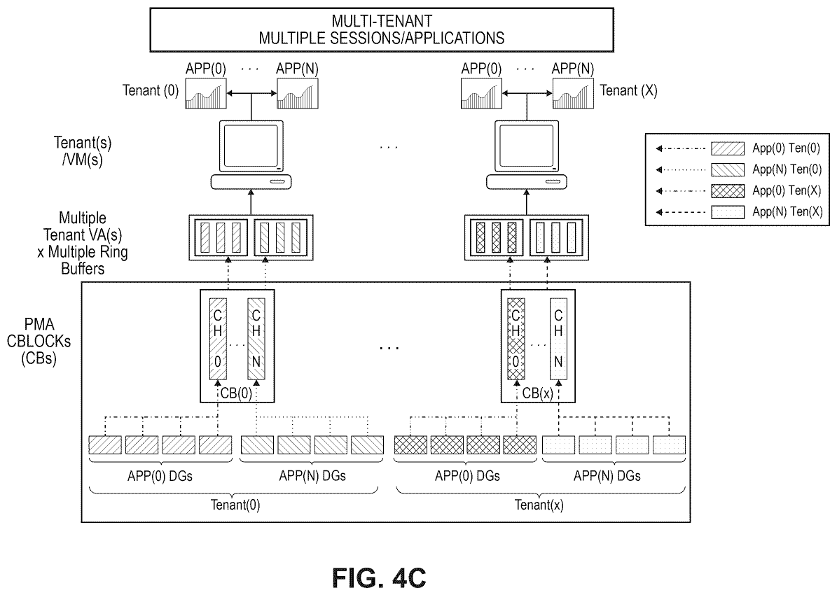

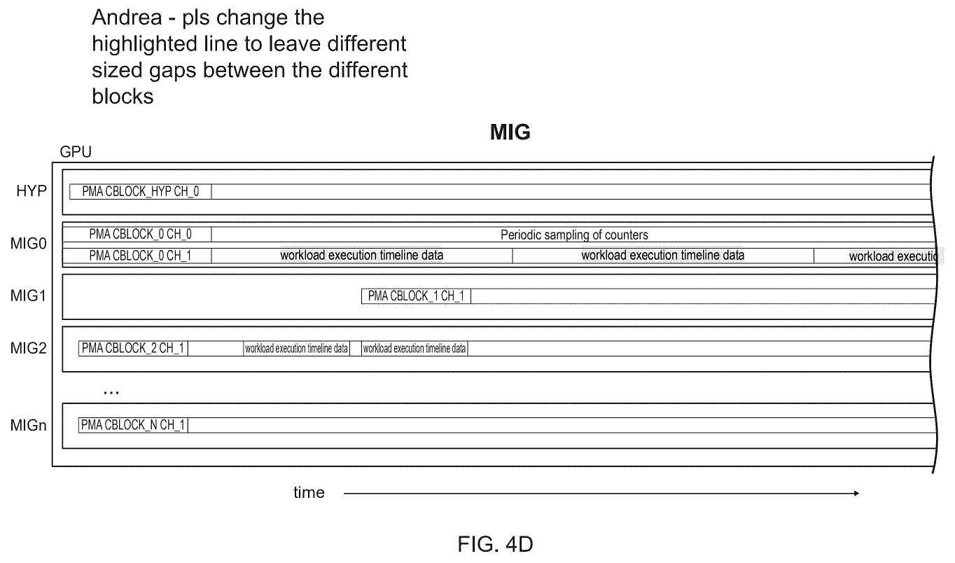

FIG. 4 shows an example computing system 50 including a processing system such as a GPU 100, a CPU/SOC 200, a memory system 300, and a consumer 1000 of data indicating the state and/or behavior of the computing system. The CPU/SOC 200 communicates with GPU 100 in order to supervise and control the GPU, send it work, and receive reports, responses, interrupts and status information. The memory system 300 may comprise a unitary hierarchical memory system comprising a number of different virtual memory (VM) partitions. The memory system 300 stores data, instructions for execution by CPU/SOC 200, and GPU applications for execution by GPU 100. In one embodiment, memory system 300 may be hierarchical and comprise a latency-hiding multi-level cache including “L2” (level 2) caches local to GPU 100 internal processing cores (which may in one embodiment comprise “streaming multiprocessors” comprising arithmetic logic units of different precisions, tensor units, shared memory, etc.). The processing cores are concurrently assigned work (e.g., execution threadblocks) from the GPU application(s) to be executed.

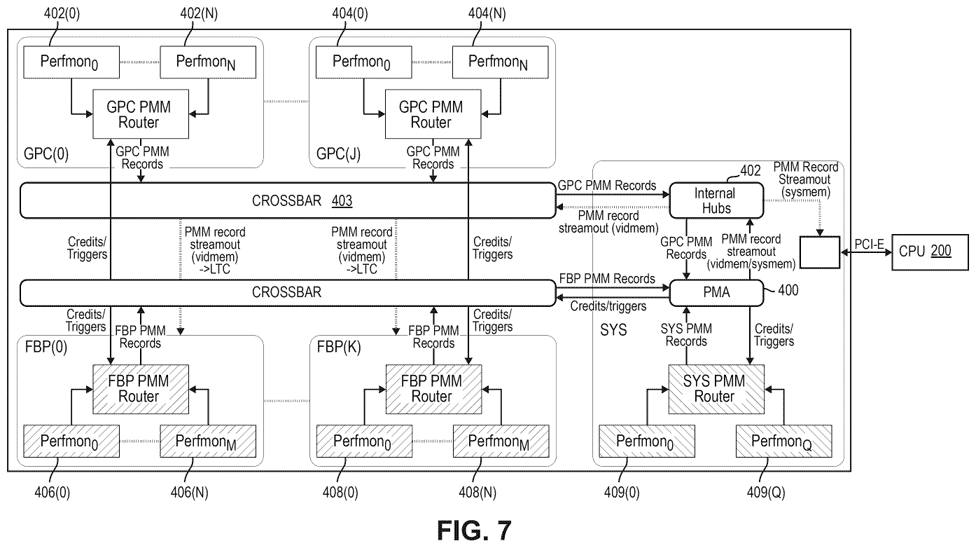

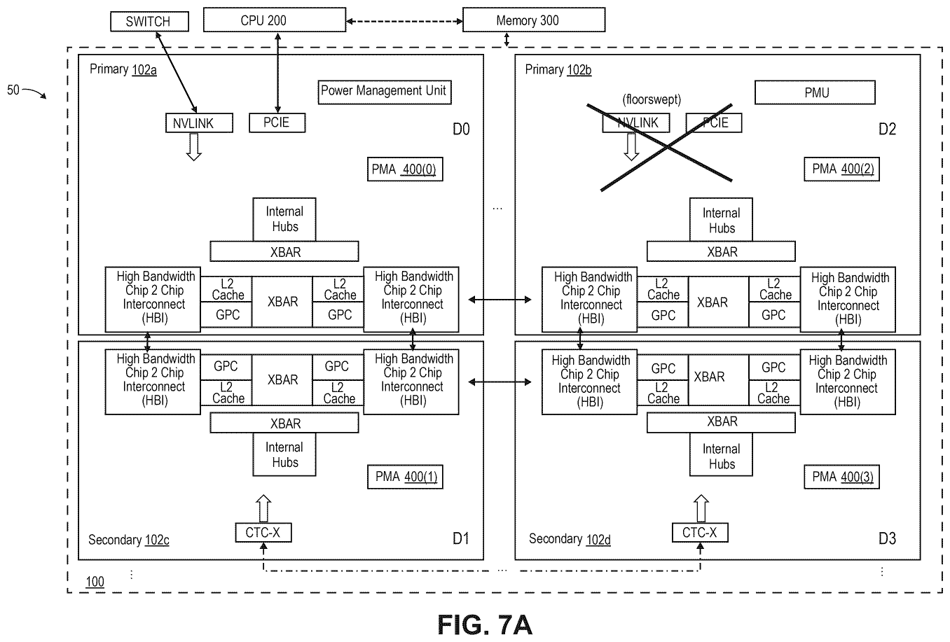

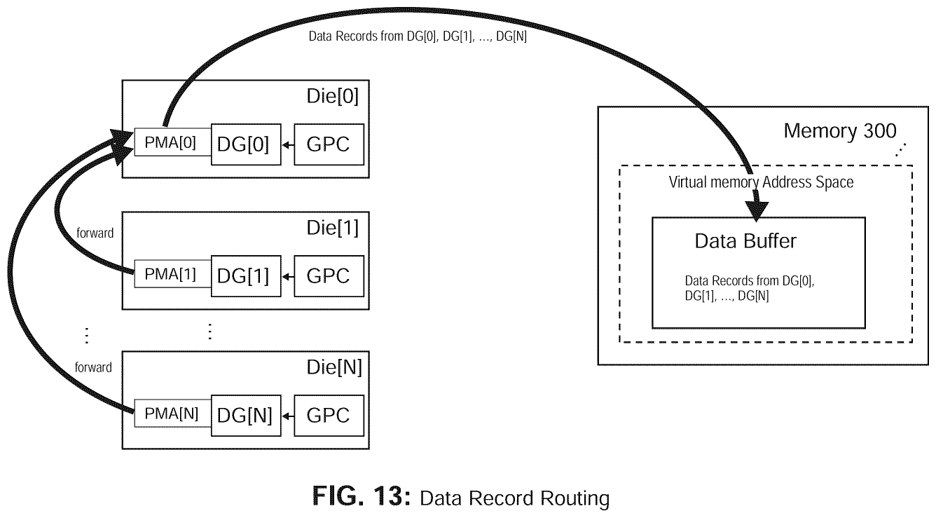

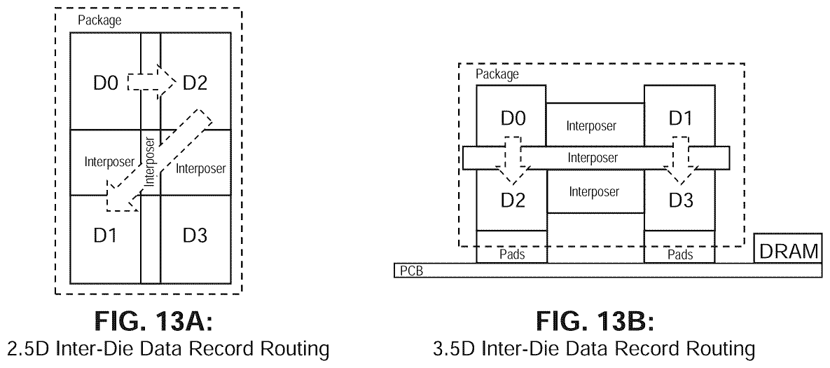

To increase the number of processing cores and thus the amount of work the GPU 100 can perform, the embodiment shown comprises multiple chip modules 102 each comprising a separate die. FIG. 4 shows a GPU distributed across two dies D0, D1. FIGS. 7A, 13A, 13B show four GPU modules 102a, 102b, 102c, 102d on respective dies D0, D1, D2, D3. Any number of dies are possible including 1, 2, 3, 4, 8, 12, 16, 24, 32, etc.

In one embodiment, each of modules 102 are identical; in another embodiment they are different or differ in certain ways. For example, the dies may be the same but with disabled features; or the dies may be different requiring unique programming. In the FIG. 7A illustration, modules 102a, 102b are identical to one another and the modules 102c, 102d are also identical to one another, but modules 102a, 102b are different from GPU modules 102c, 102d.

FIG. 4 shows that one or some dies are designated “Primary” and one or some dies are designated in some other way such as “Secondary”. In example abstractions of the hardware performance monitoring system, “Primary” and “Secondary” refer to tasks performed by the hardware performance monitoring streaming system. For example embodiments herein, “primary die” is a die with a PMA channel that streams performance monitoring related data to memory and “secondary die” is a die that uses forwarding channels to send (forward) performance monitoring related data to the primary die. In example GPU embodiments, there can be multiple sessions active in which case the definition of Primary and Secondary is based upon the configuration of the hardware performance monitoring resources. In some implementations, a given die can be “Primary” for certain performance monitoring data and “Secondary” for certain other performance monitoring data. “Additionally, “Primary” and “Secondary” need not be limited to single dies. For example, in some embodiments, the left-hand side of the figure comprises one GPU configuration (e.g., connected to CPU 200) of two interconnected dielets, and the right-hand side of the figure comprises an alternate, different (e.g., self-hosted) configuration of two interconnected dielets.

Again referring to FIG. 4, consumer 1000 interacts with system 50 to monitor GPU performance and behavior, i.e., it can request and receive information concerning what the GPU is doing and how well and efficiently it is doing it. Sometimes also called a “client” or a “profiler”, the consumer 1000 is typically enabled to customize the specific type of performance data it wants to see, e.g., so an application developer can focus in on specific behavior(s) of a GPU application as it runs. As detailed below, performance data may comprise workload execution timeline data and/or counters in some embodiments.

In the case of a monolithic GPU, software, such as, for example, GPU driver software running on the CPU or SOC 200 and consumer 1000 interacting with the GPU through such driver software, the consumer generally sees a single GPU. One of the issues with the multi-dielet GPU is to provide for consumer 1000 to continue to see a single performance monitoring, in the same or similar manner as how it can view a monolithic GPU, even though performance monitoring interface components are distributed across the several dielets in the multi-dielet GPU.

As larger GPUs are formed from multiple dielets, it is helpful or efficient to shield or abstract the consumer 1000 from having to have knowledge of the physical die layout of such a larger or non-monolithic GPU. Such shielding may be helpful, for example, to ensure that the multi-dielet GPU can be interoperable in many usage scenarios without extensive modifications to customize the consumer 1000 for each scenario. Such shielding/abstracting of the consumer 1000 from having to have knowledge of the detailed organization of the multi-dielet GPU enables, at least in some instances, the retrofitting of multi-dielet GPUs to existing consumers 1000. By providing such compatibility, the shielding/abstracting can also “future-proof” multi-dielet designs by ensuring consumers 1000 can interoperate with such multi-dielet GPUs irrespective of the GPU's specific design (e.g., number of dielets, types and number of hardware engines on each dielet, etc.). Additionally, the developer who operates consumer 1000 usually will not care which GPU resource is on which die (especially since the system may dynamically allocate work to components on different dies), but does want to know how particular GPU processing resources are behaving irrespective of which die they may happen to be on.

Example embodiments provide for shielding consumers from the many details of the underlying hardware organization. A helpful characteristic for multi-dielet GPU architectures in some embodiments is to present a monolithic or unified view of the GPU performance monitoring, in order to promote reusability and portability across many variations of multi-dielet GPUs. Ideally, consumers 1000 in some embodiments should be able to understand the GPU hardware as if it were a single unified monolithic integrated circuit on a single semiconductor die regardless of how many dielets exist and what the individual makeups of these various dielets are. This monolithic, unitary, or abstracted view provided by example embodiments extends to hardware units and engines in the respective dies as well. References to “hardware units” or “hardware engines” or “engines” herein includes but is not limited to circuits, functional blocks and processing cores or clusters of processing cores that include at least some electronic circuitry such as streaming multiprocessors (“SMs”), such as those used in graphics, compute and machine learning/AI, video encoding or decoding, units in GPC and SYS clusters, units that process work and that may in at least some context be assigned to partitioned/fractionalized MIG subdivisions, etc. These terms also include but are not limited to functional blocks including at least some electronic circuitry such as arithmetic logic units, stack controllers, memory interfaces, registers, cache memories, network interfaces, etc. found on high performance CPUs and SOCs.

Embodiments of the present disclosure focus on hardware mechanisms to present multi-dielet architectures, as a monolithic, unitary or abstracted view to profilers and other consumers, for performance monitoring purposes. This approach avoids the need to provide the profiler with information of dielet structure, such as information of what hardware engines are on which die, how to monitor performance of each such hardware engine on each die, and even whether there is only one or more than one die.

Embodiments of this disclosure thus provide multiple hardware features on each of several dielets of a multi-dielet processing system, to create a unified or monolithic view of the multi-dielet processing system for performance monitoring. However, features described herein are not limited in their utility of multi-die implementations, but may also be useful for monolithic implementations in order to for example provide efficient, scalable, channelized telemetry that can address increasingly complex performance monitoring needs irrespective of the number 1-N of dies making up a given processing system.

FIG. 4A shows that example embodiments are not limited to only one of the dies directly streaming data records to consumers 1000. FIG. 4A shows a first die 102a streaming to a first consumer or set of consumers 1000a, and a second die 102b streaming to a second consumer or set of consumers 1000b. In the example shown, the data records streamed by first die 102a can include data generated on die 102b, and data records streamed by second die 102b can include data records generated on die 102a.

FIG. 4B illustrates an example scenario in which a single tenant wishes to receive plural performance monitoring sessions. As an example, the tenant might want to monitor all processing resources with a first tool 1002(0), while at the same time monitoring hardware events for a certain subset of the processing resources with an additional tool(s) 1002(N). This scenario can be applied to single-die scenarios or multi-die scenarios, such as for example multiple sessions needing simultaneous data record streams without one stream impacting QoS of another stream. GPUs may additionally support multiple tenants on different engines with or without the use of MIG. For example, as shown in FIG. 4C, a Tenant 0 can be using the graphics/compute engine and a Tenant X can be using a different engine such as one of the following: display, asynchronous copy engine, nvenc, nvdec, nvjpg, nvofa, etc. In the case of fractional processing systems, the processing system may be a shared albeit virtually partitioned resource. In example embodiments, multiple tenants collect telemetry data for their own fractional hardware and associated DGs. Example technology herein covers the ability to support multiple consumers per-tenant while also supporting multiple tenants as shown in FIG. 4C.

FIG. 4D shows an example MIG monitoring scenario where the MIGO tenant wishes to participate in two different monitoring sessions. The top MIGO session (PMA CBLOCK_0 CH_0”) provides periodic sampling of counters, while the bottom MIGO session (“PMA CBLOCK_0 CH_1”) provides a sequence of workload execution timeline data. As can be seen, the two sessions can be asynchronous, with the bottom MIGO session being time sliced (e.g., starting, stopping and restarting) at timings that are not synchronized with any timing of the top MIGO session. Example embodiments support such flexibility by providing an enhanced command packet for the different sessions that programs data generators (“DGs”) in specific location(s) on the chip such as described in US20230297485. For example, the command packet can effectively specify “If you're listening to this session, then perform this operation”. The operation can be flexibly specified, for example START, STOP, RESET, FLUSH, and other operations that make it very easy to have multiple sessions running at the same time while making the session virtualized from the software standpoint. It is also possible to increase the number of individual sessions a MIG instance can have.

Example embodiments extend the design of Channel for multiple tenants by creating a multichannel Channel Block per tenant in the PMA. In example embodiments herein, the Channel Block defines a virtual address space of the tenant and may contain one or more channels. In example embodiments, the “Extended Channel Block” (which may be called just “Channel Block” or “CBLOCK”) shares a Bind Point with multiple buffer management instances. “CBLOCK” is thus a new concept in example embodiments where multiple buffer management instances (also known as channels now) share a (one) Bind Point.

Backward compatibility to previous designs can be derived by special casing example embodiments herein to have only one channel (as opposed to plural channels) per Channel Block. Example embodiments also extend previous solutions to provide security between different tenants and provide multi-level fairness and QoS between channels and Channel Blocks. Example embodiments also provide fairness between DGs of a given channel, between channels of the Channel Block, and between Channel Blocks along all interconnects and hardware resources—thus supporting the goal of abstracting the hardware from a consumer, e.g., so the consumer does not need to be concerned about data monitoring hardware on one die exhibiting higher latency than monitoring hardware on a different die. Independent QoS between each {CBLOCK, CHANNEL} is provided through independent credit pools and a multi-level round-robin arbitration policy.

### Example Performance Monitoring/Telemetry Architecture

Referring again to FIG. 4, each of modules 102 includes a “PMA” or “Performance Monitor Aggregator” block 400. In example embodiments, this PMA block 400 comprises or communicates with data generators such as 402, 404, 406, 408, 409, etc. for telemetry. For example, in one embodiment as shown in FIGS. 7 & 7A, the data generators 402-409 may be distributed in different areas of the die, in order to sense/measure and capture data concerning different performance parameters associated with different engines, circuits or functional blocks on the die (e.g., data generators 402 for GPC(0), data generators 404 for GPC(J), data generators 406 for FBP(0), data generators 409 for system performance monitoring, etc.) Often, a data generator is physically located next to the engine or hardware resource owned by the engine the data generator is monitoring. The data generators thus often will be distributed across the hardware circuitry. In some embodiments, different collocated or non-collocated DGs can be structured and/or programmed to monitor different parameters or parameter types. Herein, the DGs designated “402-409” are intended to include or encompass each of these scenarios and combinations thereof.

In some example operations, the PMA block 400 collects and may aggregate data the data generators 402-409 collect, for passing on via telemetry to CPU/SOC 200 and/or external profiling analysis systems such as personal computers or development systems 1000 and/or for on-chip analysis. For example, in some embodiments, PMA 400 can provide data produced by the data generators 402-409 via telemetry in real time or close to real time for real time or close to real time analysis and monitoring. In some embodiments, PMA 400 can stream some or all of such data generated by data generators 402-409 into system, video or other memory 300 for access by CPU/SOC 200 and/or an external monitoring or profiling consumer 1000. In some embodiments, PMA 400 may provide via telemetry and/or manage such data without significantly impacting other functions being performed by system 100—for example, by using telemetry data paths/channels that are separate and different from data paths the system uses for communicating data and control signals related to typical compute, graphics and/or other work the system performs.

In example embodiments shown in FIG. 4, PMA 400(0) of die D(0) communicates via telemetry with PMA 400(1) of die D(1). In the example shown, the two PMAs 400 communicate together using forwarded control paths and forwarding CBLOCKS as discussed below. In such embodiments, in this particular example, because die D(1) is “secondary” and D(0) is “primary” for streaming data to consumer 100, PMA 400(1) on die D(1) forwards data collected from some or all of data generators 402-409 on die D(1) to PMA 400(0) on die D(0). PMA 400(0) on die D(0) receives and coalesces the data forwarded by PMA 400(1) with the data it itself collects from some or all of data generators 402-409 on die D(0), and provides the aggregated data to requesting components such as consumer 1000. This inter-PMA forwarding is hidden from the requesting components and they don't need to know about it or get involved with it—they may instead interface with PMA 400(0) as if system 100 were a monolithic or unitary device on a single die, and the network of PMAs 400 distributed across multiple dies handles the complexity and communications involved in providing needed or requested functionality.

Similarly, PMAs 400 in example embodiments provide control logic that programs and commands data generators 402-409. For example, as described in more detail below, the data generators 402-409 can be commanded to select any of thousands of different signals or groups of signals to monitor, and can also be commanded to operate in any of a number of different operating modes over a number of different time scales, as well as to start and stop operating on command. In example embodiments, PMA 400(0) may be so commanded by consumer 1000 to in turn command data generators 402-409. PMA 400(0) not only commands data generators on die D(0), but also uses inter-PMA telemetry communication across dies D(0) and D(1) to similarly enable PMA 400(1) on die D(1) to command data generators 402-409 on die D(1). In one embodiment, the PMA on die D[1] forwards command information to die D[0]. and die D[0] then sends command packets via inter-chip communication to all relevant data generators. Once again, such inter-die telemetry communications does not significantly slow down or otherwise burden other system 100 communications, and is hidden from the consumer issuing the commands. To the commanding component, the command architecture and API (application programming interface) once again looks like that of a monolithic or unitary GPU processing system.

It will be noted from FIG. 7A that in some example embodiments, a given die may be “primary” for some data record sessions and “secondary” for other data record sessions. In such embodiments, the PMA 400 on each die may forward certain items to the PMA of the other die for some sessions, and may itself receive certain items the PMA on the other die has forwarded to it for some other sessions.

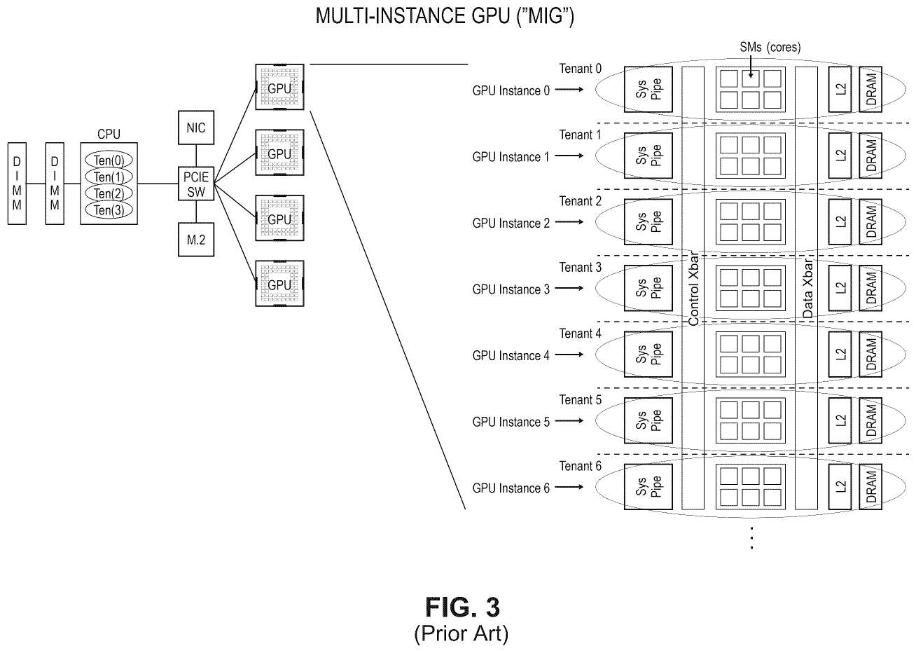

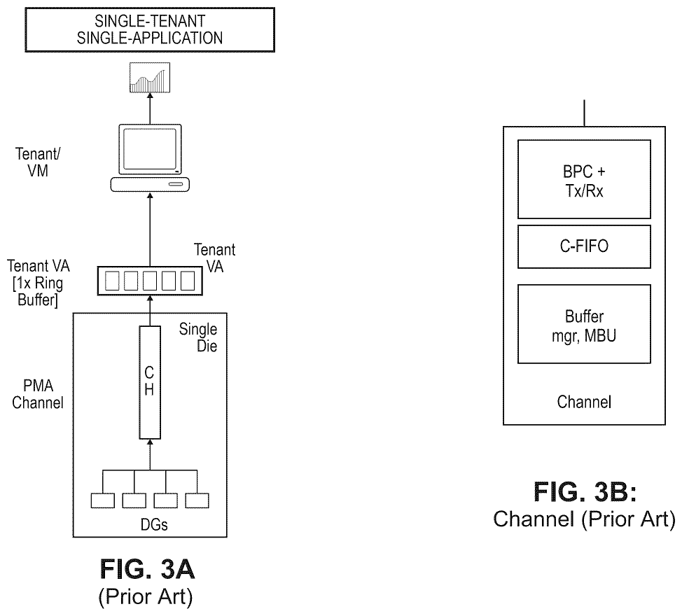

As detailed below, example embodiments provide different kinds of on-chip data generators 402-409 that perform different types of monitoring functions. However, upon closer inspection of FIG. 4, one can see that different cross-hatching of different data generators 402-409 corresponds to different communications paths as shown. This is intended to signify an additional feature of example embodiments, namely that PMAs 400 and associated data generators and telemetry communications paths/channels are able to separate monitoring and reporting functions among different applications of the same tenant, and different tenants (see FIG. 3), to ensure quality of service (QoS) and provide security between different tenants and/or users.

For example, the performance monitoring system shown can separately command and operate data generators 402-409 in different physical and/or virtual partitions of GPU 100 and separately communicate via telemetry paths/channels, data streams resulting from such separate sets of commands/operations. For example, a tenant of a first physical or virtual partition of GPU 100 can receive a first set of performance monitoring results (which may include data from plural monitoring sessions) associated with a first physical and/or virtual partition over a first set of telemetry channels, and a tenant of a second physical or virtual partition of GPU 100 can receive a second set of performance monitoring results (which may include data from plural monitoring sessions) associated with a second physical and/or virtual partition over a second, different set of telemetry channels. Neither tenant can access performance monitoring results from a physical or virtual partition other than their own, nor can they interfere with performance monitoring by another tenant within their respective physical and/or virtual partition, nor can they use their performance monitoring view(s) to learn anything about other GPU applications the GPU is running concurrently for other tenants.

As an example use case, the MIG technology discussed above may allow first and second tenants to share multi-die GPU 100, in one sharing scenario with the first tenant using first fractional parts of die D(0) and first fractional parts of die D(1), and the second tenant using second fractional parts of die D(0) and second fractional parts of die D(1), where at least some of the first fractional parts are distinct from at least some of the second fractional parts. The first tenant can issue performance monitoring commands for the first fractional parts they are respectively using, and the second tenant can issue performance monitoring commands for the second fractional parts they are respectively using (in this case, each fractional part such as a GPC may have its own respective data generators). Meanwhile, a system administrator may also be able to issue performance monitoring commands for system resources and parameters that may or may not be shared with or accessed by either tenant. The monitoring system shown keeps these different monitoring commands separate and independently communicates the monitoring commands using different telemetry channels formed e.g., from different slices of one or more time division multiplexed telemetry buses or other communications paths, so they are not confused with one another and are routed to the correct data generators.

The monitoring results produced by the data generators are similarly communicated separately and independently from one another on different channels to the proper destinations at proper timings to maintain secure separation between the data streams such that communication of a first data stream to a first destination over a first telemetry channel does not degrade quality of service or timeliness of communication of a second data stream to a second destination over a second, different telemetry channel. In the example embodiment shown, an enhanced “Channel Block” mechanism detailed below enables such separate and independent communication using multiple virtual channels. Moreover, such command and result telemetry communication is supported across dies D(0), D(1) so that any given tenant need not know there is any other tenant and/or that its processing resources are distributed across multiple dies D(0), D(1), . . . , D(N). Rather, each tenant's view into the GPU 100 may appear to a consumer as a single, entire monolithic GPU, even in instances where the tenant receives more (or less) GPU cross-die resources than might be possible from an actual physical single monolithic GPU implementation given current reticle size and process manufacturing limitations.

### Data Generators 402-409

As noted above, data generators 402-409 in one embodiment are provided in several different types to provide corresponding different functionality. The term “data generator” (“DG”) can apply to each and every one such circuit or functional block. Such data generators are typically distributed around the GPU and can be used to sense/monitor or otherwise provide data concerning different aspects of the GPU's operation such as aspect(s) of operation of engines. For example, data generators may monitor each processing core, each cluster of processing cores, each graphics pipeline, each memory cache, etc. to give insight into what each different part of the GPU is doing. There potentially are as many different types of data generators as there are types of data to be generated. Data records the data generators generate are used by system monitors, profilers, and any other internal or external consumers, functional blocks, or system utilities that need insight on GPU processing operation aspects, behavior and/or other GPU parameters of any significant part or internal component or operating aspect of the GPU. Moreover, at least some of the data generators may be programmable and/or commandable so that the profilers or other consumers are able to customize their operations to obtain precisely the type(s) of event data that is desired to be monitored at particular specified times and/or timings.

Generally for example, different kinds of profiling regimes that are supported by such data generators may include in some embodiments:
(1) capture and report workload parameters between start and stop commands;
(2) capture and report period snapshots of workload parameters (e.g., what activity occurred in the last x number of cycles).

In example embodiments, PMAs 400 reads data records each particular data generator generates and can provide them to one or more consumer(s). For example, the PMAs 400 can stream the data records a data generator generates to buffers in memory 300 thereby enabling one or more consumers to access the data reports from memory. In example embodiments, the PMAs 400 can supply such data records from different data generators to the same or different users, tenants or consumers in separate software stacks, meaning the different data record streams are not required to share a single output buffer or arbitrate outputs to a shared software stack. For example, each of a number of MIG instances can simultaneously have a workload execution timeline data session and a counter session, each session derived from a different data generator(s) and using a separate software stack. Each MIG instance can have more than one virtual channel, each channel providing different data records for different types of data generators, while still minimizing the overhead of providing such plural channels.

### Some Useful Example Data Generators

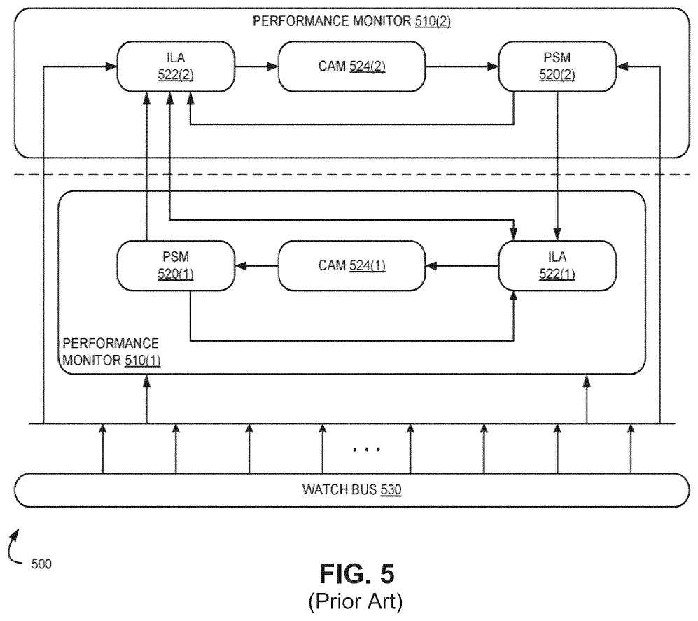

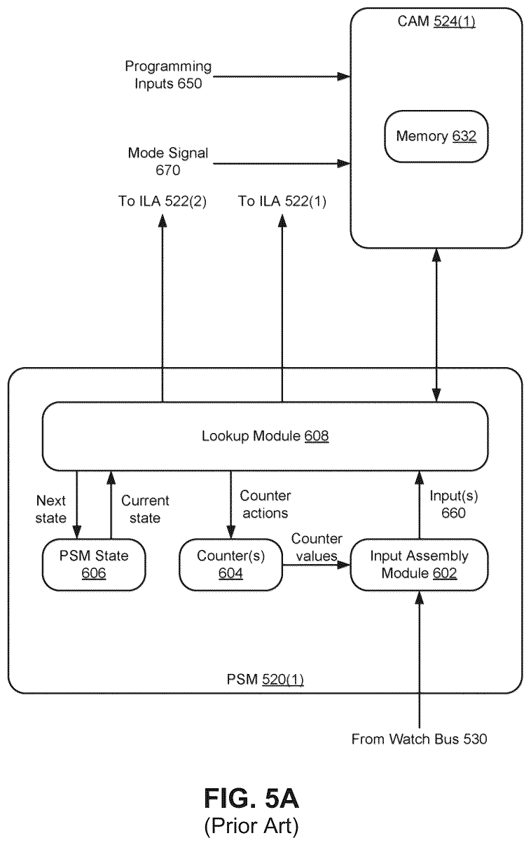

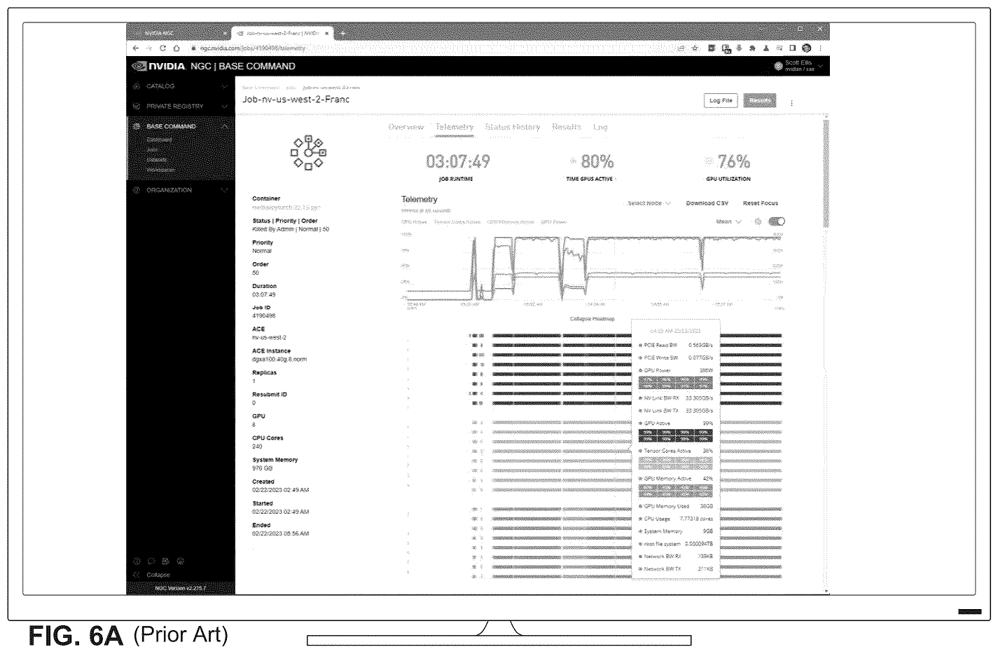

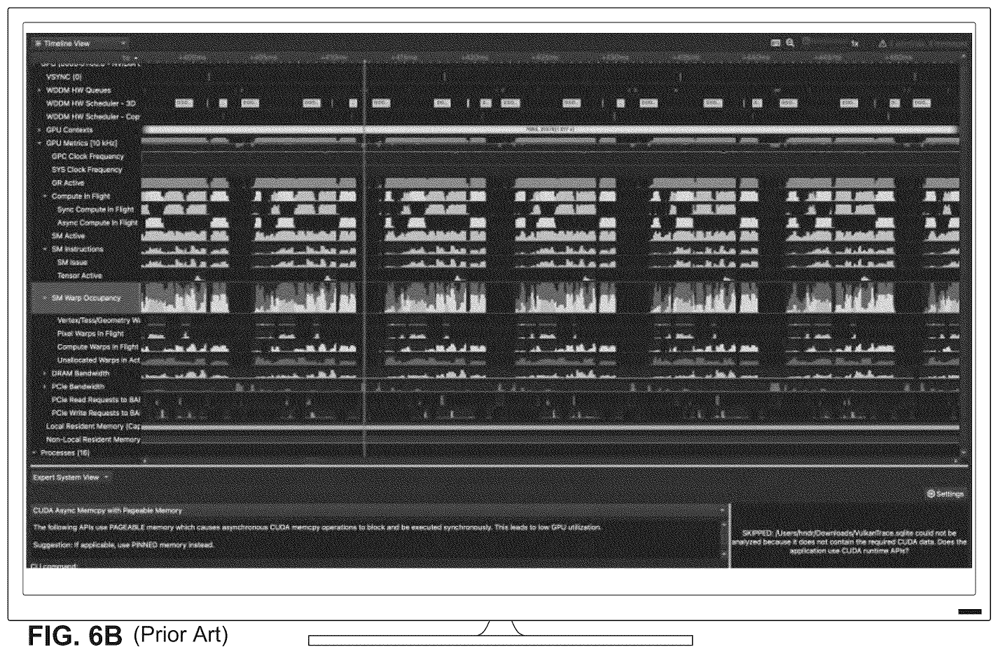

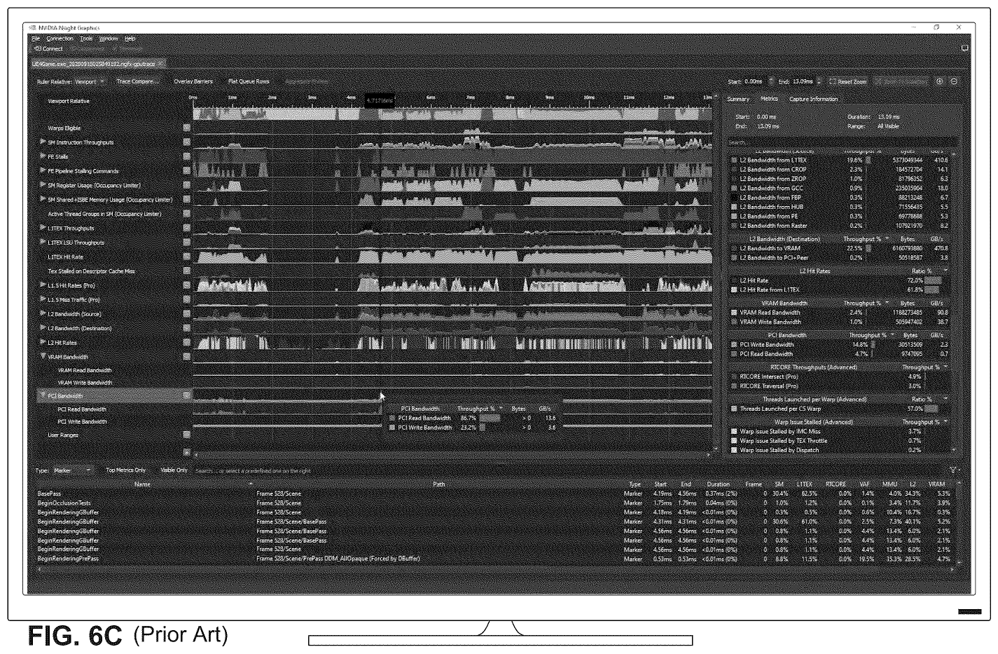

Several different non-limiting types of data generators (DGs) that may be used to implement these and other regimes. See e.g., for example US20230297485A1. In one example embodiment shown in FIGS. 5, 5A, each performance monitor 510 includes a programmable state machine (PSM) 520, an internal logic analyzer (ILA) 522, and a content-addressable memory (CAM) 524. These components monitor a watchbus 530. PSM 520 implements a state machine for the performance monitor. The state machine of the performance monitor defines one or more states, transitions between the states, and outputs associated with the states and/or transitions. ILA522 can collect signal data from one or more domains to be monitored and perform operations to analyze the data. See e.g., U.S. Pat. No. 11,687,435. FIGS. 6A, 6B, -6C show example profiler displays that can be generated from example data such data generators can provide. For example, FIGS. 6A & 6B show performance metrics of each of various hardware units executing an application. FIG. 6C indicates bottlenecks in the processing system (e.g., pipeline stalls, cache misses, read and write bandwidths, etc.) when executing a particular application.

### Example Top Level Performance Monitoring Hardware

FIG. 7 shows example hardware performance monitoring top level connectivity within an abstracted GPU design. The GPU in this example includes GPC processing clusters (e.g., for compute operations), FBP processing clusters (e.g., for frame buffer/graphics operations), and system (“SYS”) monitoring functions. In this example, the routers in each GPC (cluster of processing cores) on each die are connected to a crossbar 403 that enables the routers to stream collected data records (“GPC PMM records” where “PMM” stands for “performance monitoring module”) out to system or video memory 300 via PMA 400. PMA 400 also receives system performance records (“SYS PMM Records”) from a system performance monitoring router and associated performance monitoring data generators. Frame buffer performance monitoring data generators and associated routers supply frame buffer performance (“FBP”) PMM records to the PMA 400 via a further crossbar 404. The PMA 400 in turn provides credits and triggers (i.e., commands) via crossbar 404 to the frame buffer and GPC performance data generator routers. The CPU 200 may have read/write access to the performance monitoring system via the PCIe (Peripheral Component Interconnect Express) interface.

Example embodiments herein address how to implement such high level functionality/architecture of FIG. 7 in multi-die and/or multi-tenant scenarios.

### High Level Command and Data Streaming Cross-Die Archiecture

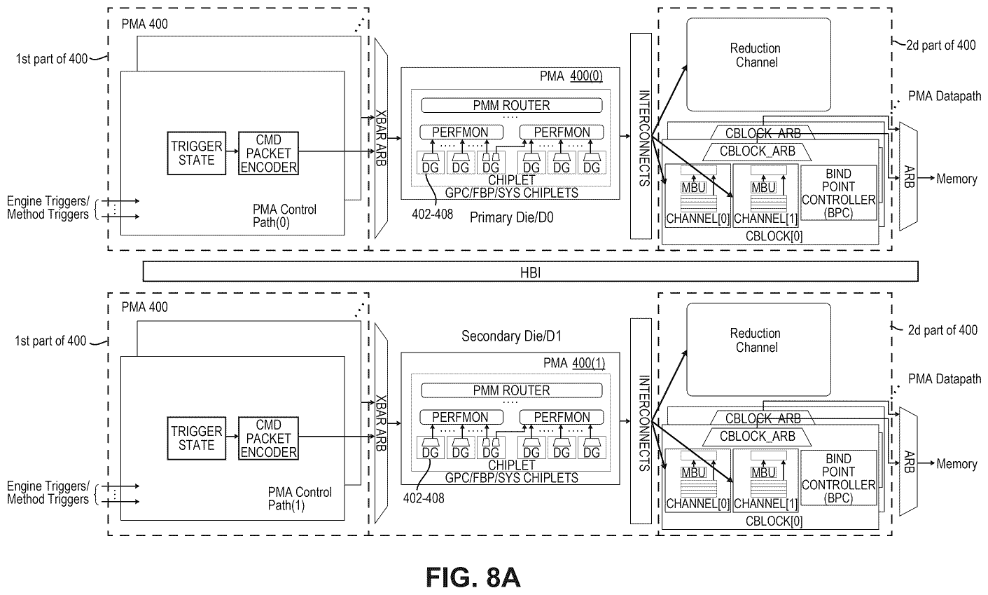

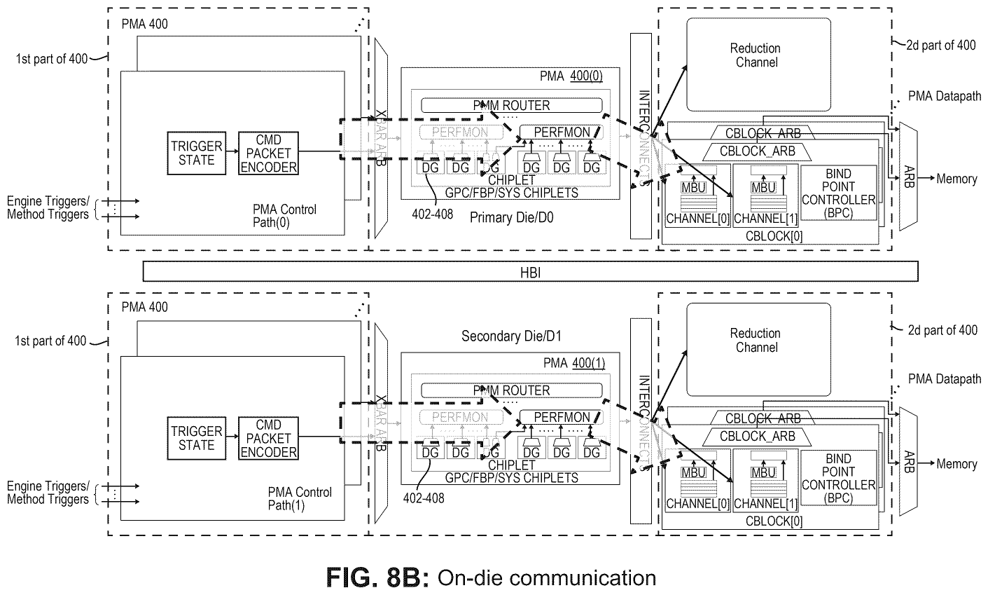

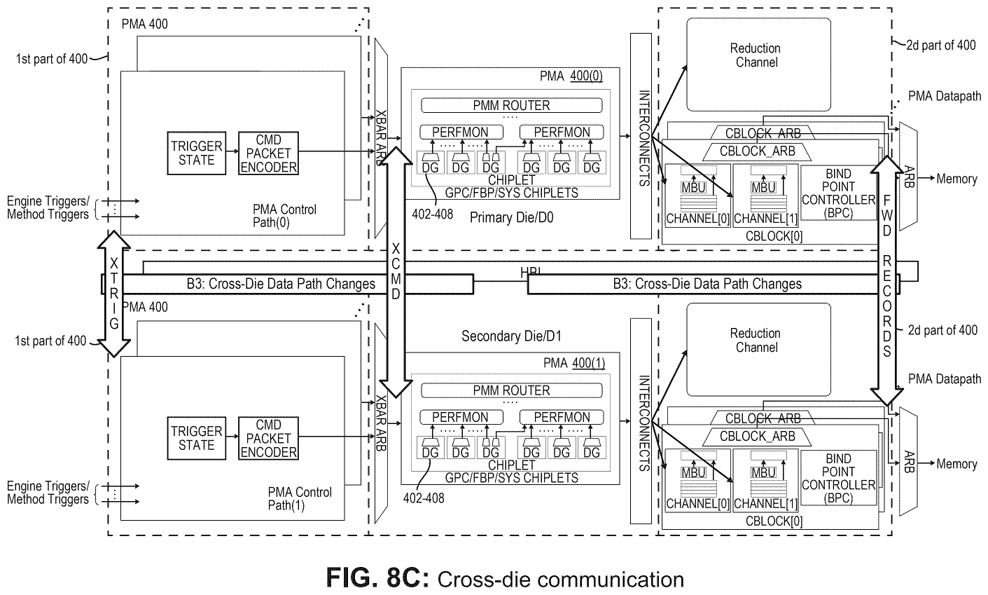

FIG. 8A illustrates high level GPU performance monitoring architecture. The top half of FIG. 8A shows a first die D(0) and the bottom half of FIG. 8A shows a second die D(1). In the example shown, each die has its own PMA 400 and data generators 402-409. The hardware performance monitoring system is thus present on both dies (each die) in a fully reflected design. In one embodiment, the PMA 400(1) on die D(0) and the PMA 400(1) on die D(1) are each instances of the same hardware design—that is, their structure may be similar or identical. Generally though, one PMA will be designated as “primary” and another as “secondary.” In the case of many dies in a multi-die configuration, there may be one “primary” and many “secondaries.” And as pointed out before, a particular PMA/die may be “primary” for some traffic and “secondary” for other traffic.

PMA 400 units resident on a given die will connect to the die-local data generators 402-409 (for engine triggers, or for unit->Data Generator connections) via their respective data routers to reduce cross-die communication requirements (i.e., in example embodiments, local die data does not need to make a round trip between the local die and a remote die to be streamed to memory from the local die).

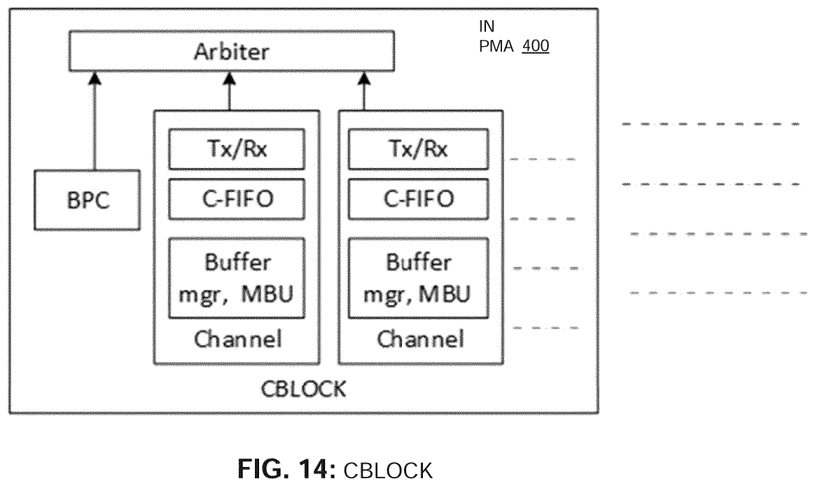

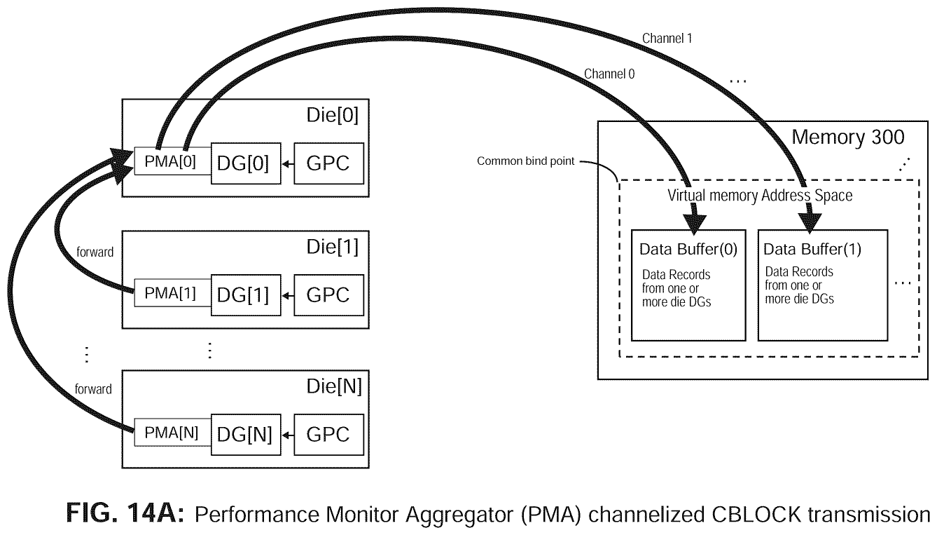

FIG. 8B shows how the FIG. 8A architecture supports on-die communication. In this example embodiment, the PMA 400 on each die provides PMA control paths—programmable processors and/or processing circuits that can be configured to observe triggers from engines, coalesce and aggregate them, and generate command packets to program/control relevant on-die data generators 402-409. One form of command packet is used to trigger on-die data generators for range based profiling, temporal profiling and/or event collection needs. In response to such command packets, the data generators 402-409 on each die perform the commanded monitoring functions and produce data records that they each provide to the PMA 400 router on the die they themselves reside on. The PMA router uses Channel Blocks (see FIG. 14) defining channels (and associated arbitration) to send such data records to the GPU's own memory and to appropriate other external destination(s) such as an external profiler device, the CPU 200 and/or system memory 300, or other consumer. As detailed herein, new example embodiments herein significantly enhance the FIG. 8B operations to make them more flexible and efficient. One significant way such operations are enhanced is to provide new cross-die functionality.

FIG. 8C illustrates, on a high level, cross-die communications that enable cross-die functionality. In a multi-die GPU embodiment, cross die information of various types flows via PMAs 400 across inter-die interconnects including “XTRIG”, “XCMD” and “FWD RECORDs” as indicated by the vertical arrows. In particular, PMAs 400(0), 400(1), . . . 400(N) on the different dies communicate with each other via a HBI (chip-to-chip high-bandwidth interface) to (1) pass hardware engine-to-PMA trigger information via xtriggers generated by forwarding trigger slices, (2) generate and transport cross-die PMA command packets (xcmds), and (3) forward PMM records from one die to the other for generating data record streaming to a consumer. This fully reflected design allows software the flexibility to observe performance metrics from resources across both (all) dies as per the MIG multiuser/tenant configurations. As the arrows indicate, full-cross die communication is supported in both directions. For internal tools, the hardware performance system can be configured to gather coalesce) information from both dies and stream out from a single channel on one die.

### Example Distributed Multi-Consumer Control Of Performance Telemetry Subsystem In A Multi-Die Chip

To provide a comprehensive solution to the problem of commanding and controlling multi-die telemetry collection, example embodiments solve two different challenges along the control path of a telemetry system in a multi-die chip:
1. Aggregation of profiling start/stop commands from engines spread across multiple dies into a PMA control path owned by a user or tenant, and
2. Communication of telemetry commands to all DGs owned by the user or tenant across multiple dies.
   Example Aggregation of Profiling Start/Stop Commands from Engines Spread Across Multiple Dies

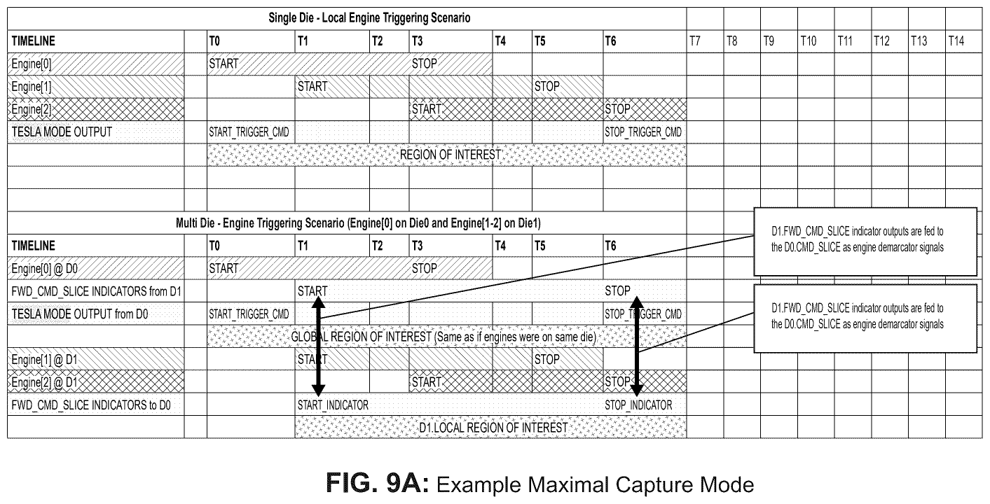

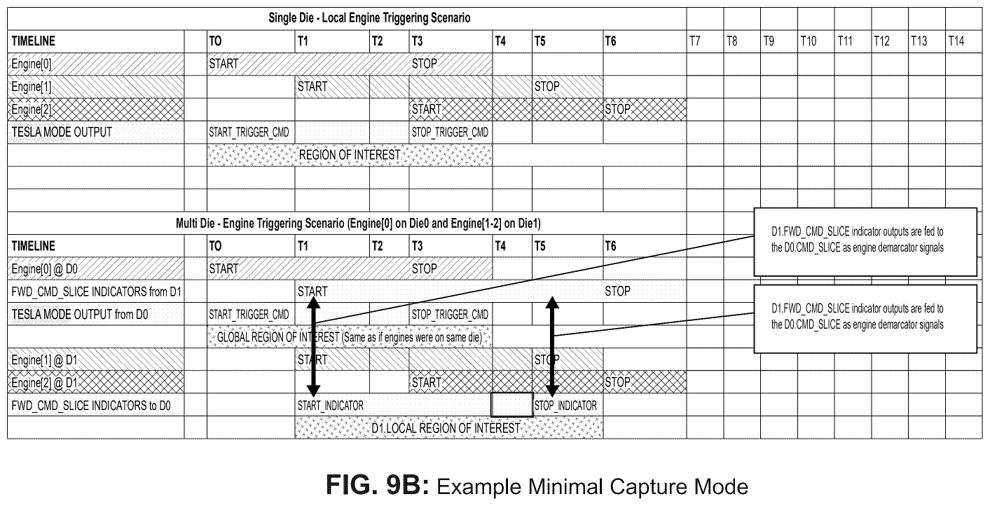

FIGS. 9A and 9B show example trigger aggregation scenarios used to control data generator capture. Suppose a user such as a tenant is using multiple GPU engines and wishes to profile such multiple engines. One common example use case is to start profiling when a start command is received from any (relevant) engine and to stop profiling when a stop command is received from any (relevant) engine. Such start and stop commands can define workload processing at any level of granularity—for example, start and stop rendering for a graphics workload, or start and stop draw for each of thousands of individual draw commands within that graphic workload that is submitted to the GPU for processing. Start and stop commands can also be based purely on timing, e.g., collect a snapshot every 10 microseconds. Or start and stop commands can be issued based on a combination of events, timing and other factors such as local clock domains. The PMAs 400 and their associated command APIs are flexible, allowing a profiler to define to a high level of precision which of thousands of signals should be captured during a flexibly-defined “temporal region of interest” or observation window specifying discrete time periods/ranges over which a data generator is to generate data.

Often, when profiling asynchronously running workloads on different engines, PMA control paths perform performance command aggregation logic so that the telemetry hardware can selectively capture the telemetry data over an:
1. Observation window between the first profiling_start command seen from any engine and the last profiling_stop command seen from any engine: This is used to capture “maximal” overlap between workloads (FIG. 9A), or
2. Observation window between the first profiling_start command seen from any engine and the first profiling_stop command seen from any engine: Used to capture “minimal” overlap between workloads (FIG. 9B), or
3. Observation window between consecutive pairs of profiling_start and profiling_stop commands from any single engine owned by the tenant: Used to capture the impact of other engines on the work done by any engine.

In the illustrative examples shown in FIGS. 9A, 9B, three engines (Engine[0], Engine[1], Engine[2]) are running asynchronously with one another. The first engine (Engine[0]) sends a start command at time TO and sends a stop command at time T3. The second engine (Engine[1]) sends a start command at time T1 and sends a stop command at time T5. The third engine (Engine[2]) sends a start command at time T3 and sends a stop command at time T6.

In the FIG. 9A example, temporal region of interest and thus data capture (“start_trigger_cmd”) begins at time TO and ends (“stop_trigger_cmd”) at time T6—i.e., with stopping of the last of the three engines to stop. The maximal temporal region of interest thus begins when the first engine starts and ends when the last-to-stop engine stops.

FIG. 9B shows a different, “minimal” capture mode where the temporal region of interest and thus data capture begins at time TO and ends at time T4—i.e., with stopping of the first of the three engines to stop. The minimal temporal region of interest thus begins when the first engine starts and ends when the first-to-stop engine stops.

These functions seem easy enough to handle when the three engines and the PMA 400 controlling them are all on the same die as shown on the top of FIG. 9A, 9B. As indicated, a prior generation NVIDIA monolithic GPU was able to automatically determine such regions of interest for a GPU all on a single die. It's sort of like figuring out which attendees of a party are older than which other attendees—each person can just shout out their birthdate so everyone else can hear. But what happens when that same group of attendees is now spread across various rooms in different cities and the communications between the different rooms needs to be fast, compact and private?

The bottom portion of FIGS. 9A, 9B show the engines now distributed across different dies of a multi-die GPU such as shown in FIGS. 7A, 8A. In the lower part of the FIG. 9A, 9B example, Engine[0] is on die D[0], whereas Engine[1] and Engine[2] are on die D[1]. In a general case, triggers from every engine on every die now potentially need to be coordinated with every control path on every die(s).

To efficiently solve this combinatorial challenge, the example embodiments use a mechanism of forwarding control paths. To implement this mechanism, the PMA 400 on each die continues to identify the local temporal region of interest for all relevant data generator commands on its local die. Because data generators on different dies can have different triggers, the different dies may come up with different answers. For example, in the FIG. 9A example, the die D[0] PMA 400 would determine a die D[0] local region of interest to be T0-T4 based on the Engine[0] parameters, whereas the die D[1] PMA 400 determines a die D[1] local region of interest to be T1-T6 based on the die [1] Engine[1]. Engine[2] parameters. Yet, common commands need to be issued to all the dies to ensure that all relevant data generators are working in a coordinated fashion—otherwise, the consumer will receive only partial results and will not be able to see what engines on each die are doing in the same temporal region of interest.

In example embodiments herein, one of the dies (D[0]) is designated as a “primary” die meaning the die with an active PMA channel. In this two-die GPU as shown in FIG. 8C, the “secondary” die D[1] is a die with the active forwarding channel so that the secondary die D[1]'s PMA communicates its local region of interest to the “primary” die D[0]'s PMA. It does so by feeding a D1.FWD_PMA control path indicator output across the inter-die interconnect to the D0.PMA control path as engine demarcator signals. The primary die D[0]'s control path takes the temporal region of interest defined by the start and stop commands on the D[0] local die and aggregates it with the local region of interest of secondary die D[1] as indicated by its respective forwarded control path. The primary die's D[0] PMA is able to treat the secondary die's forwarded control path indicator outputs as an additional set of local die input signals, and performs the aggregation function described above to arrive at the correct answer: a global region of interest of TO-T6 for FIG. 9A.

In other words, in the lower part of the FIG. 9A example, the forwarding control path function on die D[1] finds the die D[1] local region of interest (start at T1, stop at T6) and sends corresponding start and stop indicators to the primary control path in a forward control path message that essentially emulates start and top indicators generated on the local die. Such aggregation on the local die before sending results to a remote die reduces the amount of data that needs to flow between dies. In particular, the control path functions may be arbitrarily complex and combine many start and stop signals from many engines to develop a local region of interest. This determined local region of interest can however be represented by a single start signal and a single stop signal. This is not the same as forwarding each individual start and stop signal from each individual relevant engine.

The primary control path looks at these triggers as if they were just from additional engines on its local die, and makes the same decision concerning a combined global temporal region of interest across dies as if all the engines were on the same die. In this way, the primary control path can aggregate local regions of interest of other dies to develop a global region of interest that applies across all dies. The primary control path can then apply the start and stop indicators of the global region of interest to control its own die's data generators, and also communicates them to the secondary die for the secondary die to use to control the secondary die's data generators. Moreover, it will be understood that this mechanism is scalable to more than two dies, e.g., 3 dies, 4 dies, 8 dies, 16 dies, etc.

Referring again to FIG. 9A, in these examples Engine[1] and Engine[2] are on Diel (or D1) and Engine[0] is on Die0 (or D0). Considering similar workload timelines, D1.PMA control path aggregates the profiling_start and profiling_stop commands locally on die D[1] for Engine[1] and Engine[2] and converts them into local observation window indicators. These indicators are sent out as start and stop indicators to the D0.PMA control path at time T1 and T6, respectively. The D0.PMA control path then combines the local observation window of D0, delineated by commands from Engine[0] between T0-T3 and the remote observation window delineated by the FWD_PMA control path between T1-T6. Based on observation window detected, the PMA control path primes the DGs to start counting at time TO and stop counting at time T6. As seen, the hardware can identify the same observation window globally across multiple dies regardless of whether relevant engines are present locally or on a remote die. This logic works for maximal observation window of FIG. 9A and the minimal observation window case of FIG. 9B. This provides user-software the illusion that the engines are all local to the die, allows them to capture observation window commands from multiple engines, while costing a couple of wires per FWD_PMA control path->PMA control path connection for start and stop indicators. The only piece of software that needs to be die-aware is secure software in display drivers which controls how engines and their associated commands are allocated to fractional GPUs.

Meanwhile, for sake of completeness, the PMA control paths described above support additional commands that can be sent to the DGs, for example:

a) The PMA control path may be configured to generate periodic trigger commands to the DGs to capture consecutive observation windows for temporal profiling.

b) Each PMA control path can manage an associated set of DGs by sending DG management commands to reset the DGs or to pause counting based on the various operating modes present in the PMA control path.

The PMA 400 can similarly issue such command packets to all relevant DGs in example embodiments.

### Inter-Die Communication: Forward Control Path to Communicate Telemetry Commands to all DGs Owned by the Tenant Across Multiple Dies.

As explained above, the command architecture shown ensures that temporal regions of interest collected from multiple dies are funneled into a common central PMA control path destination (which in example embodiments is disposed on a die designated as “primary”) from which centralized point the resources on all of the multiple dies may be commanded. This control is accomplished in example embodiments by communicating commands over a PMA-to-DG path.

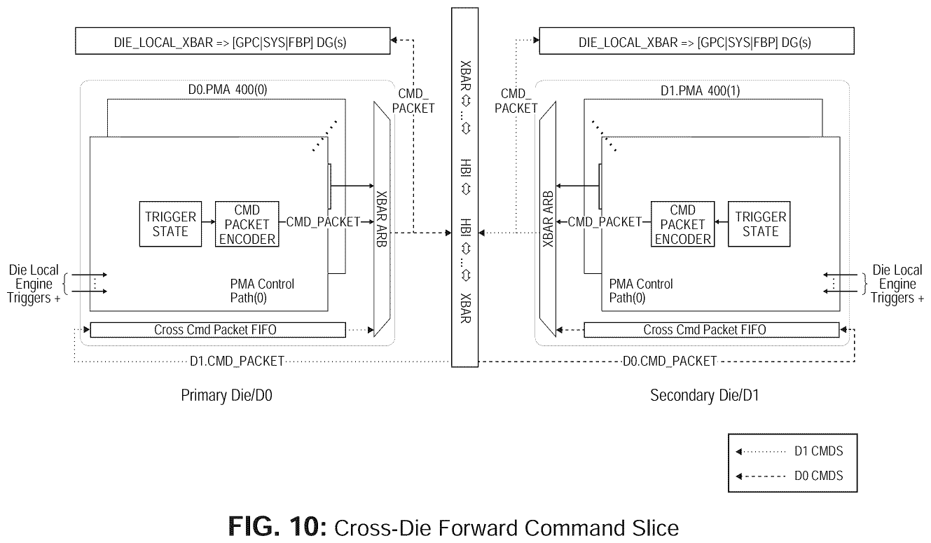

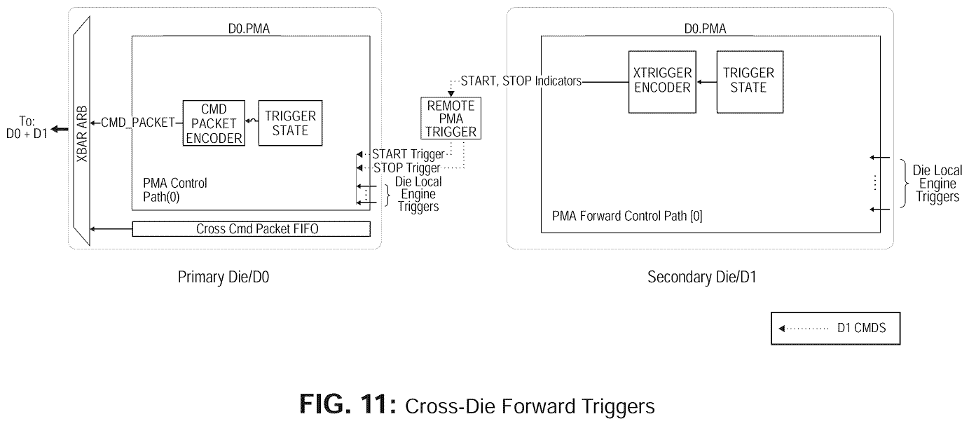

FIG. 11 shows an example multiple-die control path (“control slice”) layout to enable this. FIGS. 10 & 11 show that each PMA comprises multiple control path logic blocks. These control paths arbitrate over the same command bus Local engine triggers coming in to each control path logic block from the local engines on the same die. The PMA further has PMA forward control path logic that acts as a kind of proxy observer for the primary PMA control path. The PMA forward control path logic is configured for the engine that belongs to or is associated with a specific kind of control path that is on another die. The PMA forward control path logic then acts like a subscriber and publisher for the information to the primary PMA control path. The PMA forward control path logic collects all of the information locally, and identifies the local temporal region of interest the collection of locally collected information indicates as described above. The PMA forward control path logic then sends the corresponding start and stop triggers for the identified local temporal region of interest to a primary or centralized PMA control path on another (e.g., the “primary”) die via a die-to-die interconnect. These start and stop triggers appear as REMOTE_PMA_ENGINE triggers on respective PMA control path inputs, and appear to the remote primary PMA control path logic on the remote die as additional die local trigger signals from engines local to that die. See FIG. 11. The remote, primary PMA 400 can thus calculate a global region of interest as described above the same way it would calculate a local region of interest, and provide global start and stop trigger signals to local and remote (to it) data generators to command and coordinate data collection on both its local die and the remote die(s). Meanwhile, the consumer 1000 generating the commands does not need to care where any of the data generators are, it just specifies what should be monitored during a temporal region of interest and the GPU hardware takes care of the rest.

### Triggers for Multi-Engine Workloads

Start and stop triggers can also be generated periodically to snapshot registers. Trigger Indicators map at the primary control path logic to output trigger state after local trigger coalescing (e.g., same as triggers if running single engine workload):

[D1=>D0: Multi-engine traces with engines running on D0 and D1]
D1.ENGINE=>D1.PMA.FWD_CONTROL PATH=>[D2D_WIRES.{START, STOP}]=>D0.PMA.REMOTE_PMA_ENGINE.{START, STOP}=D2D_WIRES.{CMD_PACKET}
D0 coalesces remote PMA triggers with local die triggers for multi-engine traces
D0 sends out the CMD_PACKET.

### Interconnect View of Inter-Die Forwarded Communication (e.g., Forwarded Triggers, Forwarded Command Packets and Forwarded Records)

As FIGS. 8C, 10 & 11 indicate, for forwarding PMA records, a PMA->PMA message interface between the multiple dies is supported between multiple dies using cross-die message interconnect (C2C-MI) and an interface called pma2pma_msg. Xtrigger and xcmd interfaces are added over crossbar 404 for coalesced trigger forwarding and for command packet propagation to the other dies. An arbitration scheme is used wherein local control paths on each die operate independently of local control paths on every other die, but can broadcast information across multiple dies to provide multiple die control from a single control path:

Example CMD_PACKET_FLOW [D0=>D1: Device Level Profiler, Monitoring]
D0.ENGINE=>D0.PMA.CONTROL PATH=>[D0.LOCAL_XBAR+D2D_WIRES]=>[D1.LOCAL_XBAR]=>D1.PMA=>[D1.LOCAL_XBAR]=>[D1.DG(s)](i.e., Remote PMA forwards the command packet to local PMA and the local PMA forwards it to local DGs.)
If the CMD_PACKET from PMA control path=>Broadcast to device local XBAR && D2D.XCMD wires
If the CMD_PACKET from INPUT=>Broadcast to device local XBAR

This delegated and distributed approach has several advantages including:

1. It allows the remote command ingress and egress to be customized for backpressure mechanisms specific to interconnects between the source and destination die

2. It allows flexible QoS service mechanisms between local command packet dispatch and remote command packet forwarding depending on the source of the commands.

3. It reduces the wires in any given die as local DGs only get commands from local PMAs.

4. It reduces the bandwidth, wires, and power requirements to obtain observation windows of interest across multiple dies.

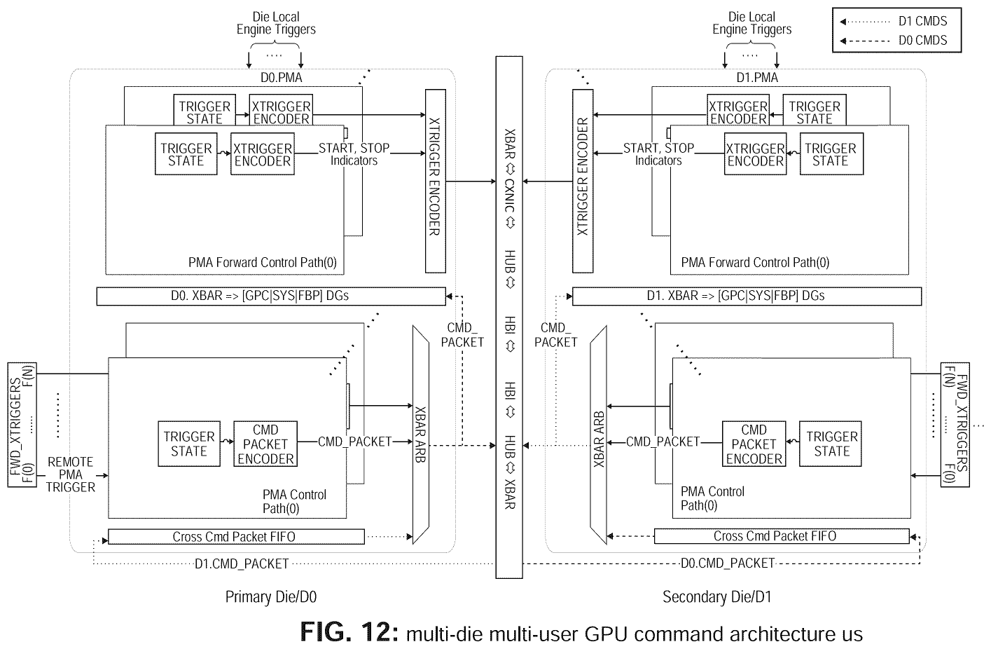

5. In a heterogenous multi-die system where the interconnects between two dies may not be uniform, PMA forward control paths can be customized to handle backpressure or buffering on its interconnect to its primary PMA control path. An example of this can be seen with the XTRIG_FIFO (first-in first-out buffer) at the egress of the FWD_CONTROL PATH(s) shown in FIG. 12.

6. Because each PMA control path can control DGs across multiple dies, user software is agnostic of where the DGs are in a multi-die.

7. Scales for both homogenous and heterogenous multi-die architectures. For example, in a SOC<=>GPU multi-die system, the GPU PMA control path can control DGs present on both the GPU and the SOC.

Example embodiments thus outline a distributed control system for telemetry collection where regions of interest are first identified locally and communicated to a global PMA control path controller. This avoids fully decentralizing the control of telemetry across multiple dies either increasing software overhead or using more communication resources. It is not necessary to rely on using a single engine or single PMA to identify regions of interest, which may not support capturing regions of interest for multi-engine GPU applications across dies. Example embodiments herein further support a multi-die observation window identification across both SOC and GPUs.

Example embodiments are scalable of the 2.5D vs 3D scaling used in multi-die chips, use limited set of wires, use limited bandwidth, and interfere at an extremely minimal rate with functional traffic that is being transmitted on any shared interconnects.

Example embodiments facilitate the tenant resources to be present in multiple dies, and do not limit the resource usage to a single die with a single controller.

### Example Multi-Tenant MIG Scenario

With the ability to dynamically configure the GPUs into fractional GPUs, the following scenarios (any subset thereof) may be running simultaneously with another subset of applications in a multi-die chip all of which can be accommodated with the distributed control mechanism discussed above:
Device level profilers (run at hypervisor or when the tenant owns the entire GPU) while the GPU itself may be optionally partitioned in MIG mode.
MIG GPU instance level profilers (running inside a virtual machine (VM) or the container observing multiple MIG compute instances owned by the tenant)
MIG Engine level profilers (being able to observe a single MIG compute instance)
MIG process level profilers (where the per-process configuration and telemetry collection for the duration when process is resident on the MIG instance)
Timesliced VM level profilers (where VMs may themselves be timesliced over MIG GPU or compute instances)
Device level Hardware Event System (HES) collector which can collect workload execution timeline events from all the MIG instances
MIG GPU instance level HES collector that can collect kernel lifetimes events from MIG compute instances in MIG instance.
MIG Compute instance level HES collector that can collect kernel lifetime events for a specific MIG compute instance.
Process level HES collector that collects events for the kernels launched when context is timesliced onto the device
Timesliced VM level DGs (where VMs may themselves be timesliced over MIG GPU or compute instances)
In-band process level monitors (running inside the VM or container and using NVIDIA display drivers)
In-band VM level running within the VM or on mediated by the hypervisor
In-band device level monitors
Out-of-band device level monitors (typically running on behalf of the cloud service provider controlled via Baseboard Management Controller (BMC) or similar controller not managed by the display driver).

In a MIG use case where multiple tenants share the same GPU distributed across multiple dies, each of the PMA's control paths acts like a controller for a tenant's application (multiple tenants use different sets of PMA control paths). It sends out commands to prime the DGs associated with a given GPU application of that tenant to start and stop performance metric capture. Additional commands for temporal profiling as well as telemetry management commands also need to be sent to telemetry hardware components associated with that tenant that may reside in multiple dies. As DGs can be dynamically associated with any tenant based on security, or even how the GPU is partitioned into MIGs, every PMA control path(s) would need to communicate with every DG in the multi-die scenario. This approach is not scalable. Hence, a delegated approach for command propagation to multiple dies is used. In this delegated approach, the DGs have a single command interface which is programmed to subscribe to a specified PMA control path by secure software. The local PMA control path first arbitrate with each other to send out their respective commands on a single interface. In one embodiment, each command is identified by a CONTROL PATH ID uniquely assigned to the PMA control path in the system. If a command(s) needs to be sent to remote dies, it is first sent to the PMA 400 on the remote die via PMA2PMA (“PMA-to-PMA”) interconnects. The remote PMA then arbitrates and provides quality of service (QoS) between local command dispatch and any commands it has received from the remote die. As a result, each DG can listen to a single command interface on which the die-local PMA injects commands generated from local as well as remote PMA control paths.

In a MIG use-case whose GR engine is on Die[X] but needs to coalesce with triggers from another engine owned by the MIG on Die[Y], the system uses Die[Y]'s forwarding control paths to gather the engine triggers on Die[Y] and sends coalesced trigger indicators to the Die[X]. Die[X] will then coalesce the engine triggers from Die[X] and Die[Y] to generate command packets. The command packets will be sent to both dies but not directly; they will be first sent as XCMDs to the remote die which will then broadcast the command packets locally to the local data generators using local trigger paths. See FIG. 8C.

Example: [D1=>D0: Multi-engine traces with engines running on D0 and D1]

D1.ENGINE=>D1.PMA.FWD_CONTROL PATH=>[D2D_WIRES.{START, STOP}]=>D0.PMA.REMOTE_PMA_ENGINE.{START, STOP}=D2D_WIRES.{START, STOP}

D0 coalesces remote PMA triggers with local die triggers for multi-engine traces

D0 sends out the CMD_PACKET.

Thus, the die local PMA 400 essentially functions as a kind of centralized local controller for the tenant's DGs on that die. However, PMAs may forward command packets to PMAs on other dies. A remote PMA thus can take the cross command packets and forward them to its local die. In such embodiments, the only components on different dies that need to talk to one another for telemetry and performance monitoring are the die local PMAs. They each know how to communicate information to their respective local resources on the same die. This simplifies the logic on each die to support multiple dies, since the same command logic that supports local die commands is also used to support cross-die commands. It also provides a distributed system where each die's PMA is responsible for commanding that die's own data generators. The additional die-to-die communication is then used to influence the command operations on each die, thereby dynamically configuring the hardware on each die (e.g., along MIG boundaries) at run time. This enables, for example, software to dynamically configure the performance monitoring command functions at run time as MIG configurations change (e.g., new tenants are added, old tenants vacate, etc.) to support the various sessions and time lines discussed above.

### Multiple Consumers, Multiple Tenants

As noted above, example embodiments not only accommodate multiple users/tenants but also multiple consumers per tenant.

Example embodiments have the flexibility to collect observation windows for each tenant independently and for independently for multiple consumers of each such tenant. For example, a hypervisor tenant can be obtaining performance commands from all engines across the entire device (where say a profiler is running in device mode using D0.CONTROL PATH[x] and its associated FWD_CONTROL PATHs in other dies), while the HES subsystem can be running in MIG mode obtaining performance capture for each graphics engine using independent CONTROL PATH(S) and FWD_CONTROL PATHs from both D0 and D1. Example embodiments support numerous combinations of telemetry running concurrently and observing their own resources. It is not restricted to just a few applications where the tenant may be required to obtain the entire GPU for telemetry collection.

Additional triggers and associated PMA control can be supported by simply replicating the FIG. 10 architecture to provide many PMA control path circuits and many PMA forward control path circuits within each PMA 400 FIG. 12 shows an overall example multi-die control path wherein each PMA on each die includes multiple (1-N) control path logic blocks and multiple (1-M) forward control path logic blocks (where N, M are each positive integers). This architecture supports many consumers in parallel each of which can program and use plural or multiple data generators for monitoring purposes. The architecture further supports multiple users/tenants to each have their own respective programmable performance monitoring and associated programmable data generation operations, each with separate QoS and dynamically individualized programmable start/stop of individual monitoring sessions.

In example embodiments herein, multiple tenants are supported by allocating each tenant a “SliceBlock” (SBLOCK), which further consists of the PMA control paths in the PMA 400. As noted above, the PMA control paths are programmed by secure software to receive observation window commands from the engines allocated to the tenant or to the tenant's profilers or other consumers. Each tenant can be allocated multiple PMA control paths for multiple consumers the tenant is using to monitor its fractional GPU hardware and the behavior of its GPU applications running on that fractional hardware. For example, a tenant may have one PMA control path for managing its profiler or other first client application and a different PMA control path for managing its workload monitor or other second client application, respectively. Hence, multiple independent monitoring clients per-tenant can also be supported.

### Example Use Case

For example, when a tenant owns the entire GPU, the hardware resources owned by the tenant, namely various GPU engines (video accelerators or graphics engines), memory, and/or interconnects are spread across multiple dies. In this case, the telemetry subsystem needs to identify, in hardware, the maximal (or minimal) overlap between asynchronously running workloads across engines in different dies in the manner described above. Any resultant control of telemetry hardware based on this information to start or stop performance capture, reset telemetry components, or to pause the collection of telemetry data also is supported across multiple dies.

On the other hand, as the GPUs get partitioned into fractional GPUs or MIG instances, where the GPU itself is a shared albeit partitioned resource used by multiple tenants, the resources for any given tenant may get localized to a single die or may be spread across fractional portions of multiple dies. In this case, the hardware of example embodiments supports aggregation of performance commands for each tenant independently across dies. Furthermore, the hardware is able to control each tenant's subset of telemetry resources across multiple dies.

### Example Variants

Several additional variants can be supported in this scalable design. Outlined below are a few examples—note also that the present solutions are extensible to both homogeneous and heterogeneous multi-die architectures.

1. Multi-die system consisting of ‘N’SOC(s) containing CPU (Central Processing Unit) cores <->‘M’fractional GPUs: A tenant can own certain number of CPU cores across multiple SOC (System on Chip) dies and a fractional GPU consisting of hardware resources obtained from multiple GPU dies. In this case, there will exist FWD_PMA Control Paths between SOC and GPUs (or even between SOC dies and GPU dies), so that profiling start/stop commands can be locally aggregated in respective dies, and the start/stop indicators transmitted to the PMA control path observing fractional GPU workload. This PMA control path can then determine the global observation window and control telemetry hardware across multiple dies.

2. Multi-die system consisting of an engine-level dielet where graphics engines and compute resources are on die 0 (D0) whereas engines like decoders and encoders are on die 1 (D1). In this case, a stripped-down version of PMA 400 consisting only of FWD_PMA control paths can be instanced in D1. In D1, the FWD_PMA control paths aggregate performance capture commands from its local decoders/encoders engines, and then transmits local region of interest indicators to the PMA control path on D0. The PMA control path on D0 in turn aggregates the indicators with performance capture commands from graphics engines to identify global region of interest.

3. Given appropriate latency constraints, the indicators can be sent over varying sets of interconnects. For example, this concept can be extended to multi-chip packaged systems connected via NVLINK or other similar packet-based flows.

### Example Data Record Reporting

A result of the distributed command arrangement discussed above is data generators generating command-specified data records during command-specified temporal regions of interest. The data records are potentially numerous given that different users/tenants can receive different data records and different clients of the same users/tenants can also receive different data records.

A goal of example embodiments is thus not only to minimize burdens of performance monitoring data reporting on GPU workloads, but also to prevent different data report streams from interfering with one another. Each data record consumer should be able to get certain QoS for data records it receives irrespective of what other or how many other consumers are also consuming data records at the same time. Additionally, one consumer should not be able to use performance monitoring to snoop on GPU workloads another consumer has submitted to the GPU.

While some prior approaches simply duplicated the same data record outputting functions for each die in a multi-die system, clients such as profilers and hardware monitors then need to manage and correlate contents of separate die data buffers. Having each die separately write its performance monitoring data records to memory is potentially a nightmare scenario in terms of backward compatibility, increases memory bandwidth usage, uses extra power and has other disadvantages such as requiring specialized clients to correlate monitoring data collected at or about the same time across multiple memory buffers.

Example embodiments provide both separation of monitoring GPU applications among different users or tenants, and also separation of monitoring performed by monitoring clients of the same user or tenant, while giving profiler and other clients an interface to data records for the GPU as a whole (e.g., as if it were on a single die) instead of die-by-die.

### Extended Channel Block

Generally, when example embodiments write performance monitoring data to memory, they write the data records into virtual address spaces. The system can write different data streams into different virtual address spaces accessible by different tenants. The performance monitoring hardware automatically writes data records into the tenant's own virtual address space without requiring a lot of interaction between any kind of underlying hardware or hypervisors.

To accomplish the above, example embodiments implement Channel Blocks of FIG. 3B in a new way that controls the virtual address spaces of multiple tenants. Within this improved Channel Block construct there now is a scalable concept of virtualized channels supported by hardware. If a data generator is trying to stream to a remote channel, the supporting hardware provides channel virtualization. The PMA 400 provides a lookup table that distinguishes between data streams for local die Channel Blocks and data streams for remote die Channel Blocks.

In more detail, in example embodiments Channel Block has following properties:

A Channel Block has its own Address Space Identifier (ASID) and hence, can bind to an instance block with its own virtual address (“VA”) space.

Each Channel Block represents plural virtual channels over which data records can be written. Each channel in turn defines a buffer for streaming DG records to memory.

Channels within Channel Block fault together. The bind point controller (“BPC”) is responsible for monitoring the fault state of the Channel Block and doing fault recovery.

Channels within Channel Block stream to distinct memory locations in the same VA space of the Channel Block. Each channel has plural buffers, and hardware is responsible for defining their boundaries such that they do not overlap with buffers for other channels in the Channel Block, for example by using:
A circular buffer for data streamout
A single address location for storing the number of bytes written to that buffer for indication to software.

In example embodiments, each channel has a predefined priority for utilizing the bandwidth allocated to a Channel Block. In one example embodiment, all channels may have equal priority. Thus, a Channel Block may use a round-robin arbiter to arbitrate between its channels and the bind point controller.

Referring once again to FIG. 4, suppose one of the data generators on Die D[1] is streaming data records through die D[0] for die D[0] to write to memory. The data generator can be constructed as if it were sending its data traffic locally on its own die D[1], and the records come into PMA 400(1). PMA 400(1) includes a PMA device routing table as shown that performs dynamic routing based on Forwarding Channel Blocks die-to-die. In example embodiments, a Forwarding Channel Block defines a proxy channel block associated with a primary Channel Block in remote dies. The PMA Device Routing Table of PMA 400 (1) uses forwarding CBLOCKs to identify data records destinated for remote PMAs, and routes these data streams to the PMA 400 of remote die D[0]. The PMA on D0 in the PMA 400 receiving the data records from D1's forwarding CBLOCKs will thus receive data records from local (same die) and remote (different die) data generators and can write data records from both originations to a common data buffer in virtual memory. The PMA 400 receiving the Forwarding Channel Blocks will thus receive data records from local (same die) and remote (different die) data generators and can write data records from both originations to a common data buffer in virtual memory. This enables a client to have a performance monitoring data view of its (potentially fractional) allocated virtualized GPU (which may be distributed across any number of dies) as a single unitary processing system. It also simplifies memory translations by avoiding the need for separate or additional memory translations for different dies. In example embodiments, routing tables in each of the local PMAs can then redirect traffic like a network switch to any of the remote PMAs.

An external controller for example does not need to know which die to look to for receiving command acknowledgements from data generators—the hardware takes care of routing such command acknowledgements through an appropriate Channel Block virtual channel to a memory buffer that contains data reports from any number of dies. This is illustrated in a simplified manner in FIG. 13, where PMA routers on the respective dies each forward respective data reports from data generators DG[1], . . . , DG[N] on the respective dies D[1], . . . , D[N] to a PMA[0] data router on e.g., die D[0]. It should be noted that in example embodiments, each die can forward data from any number of data generators, and that this is just a simplified illustrative example.

The PMA[0] data router on “primary” die D[0] streams out the data from both remote die and local die to the virtual memory buffer. For example, PMA[0] will collect data records from DG[0] on die D[0] and then write data records from DG[0], DG[1], . . . , DG[N] out to a common data record buffer in virtual memory over a single path to memory, for access by user software. The user software does not need to get involved with how to read data reports from each individual die or even know there is more than one die—the hardware takes care of this routing and memory translation complexity in a way that is hidden from the client so the user or tenant gets a virtualized, die-independent view of the data records generated by data generators distributed across dies. And the use of a common memory path simplifies memory translation, memory barriers, flushes and other overhead involved in writing the data buffer to memory as compared to a scenario where each die needs to write its own data records separately to memory.

In example embodiments, coherence between the forwarded and native Channel Blocks is provided in part by allowing flushes to occur on a single channel basis rather than on multiple channels. However, since the synchronization will not be perfect, the user software may need to do a bit of reserialization of data records written to the memory data buffer. For example, a PMA 400 that streams to memory may be able to write its local die samples associated with a trigger with lower latency than it can write remote die samples associated with the same trigger which were forwarded to it over a die-to-die interconnect. The user software can use trigger count and time stamps carried in example embodiments as part of the data records to correlate data record samples from data generators on different dies.

FIG. 13 illustrates a scenario for one tenant or user, but the same process can be replicated to occur simultaneously for data generators of any number of other tenants to write into other virtual memory buffers respectively owned by such other tenants, consistent with hardware resources. Secure software can be used in some embodiments to set up the routing initially so only authorized tenants get access to their associated respective virtual memory partitions. In example embodiments, the routing information is programmable in the hardware and so is not limited to Channel Blocks but could forward any kind of data packets between dies in any kind of hardware structure such as SOC and GPU, e.g., for routing data between a GPU die and an SOC die, etc.

FIG. 13 shows PMA routers on dies D[1]-D[N] each forwarding their data traffic to die D[0]. However, other routing topologies are possible. FIGS. 13A, 13B illustrate alternatives in the context of 2.5D and 3D chip packages. In FIG. 13A, assume that each of dies D[0], D[1], D[2], D[3] are identical. Depending on the interposer or interconnections between the dies, D[0] could route to D[2] which routes to D[1]. Or if the interposer permits it, D[0] could route to D[3] directly. By merely changing the routing table and instantiating appropriate routing resources, it is possible to support any sort of die routing topology. In the FIG. 13B 3.5D scaling comprising a three-dimensional stack of chips/dies, the dies may not be identical; dies D[0], D[1] may comprise computation engines and resources and associated support components, whereas dies D[2], D[3] closest to pads connecting the package to the printed circuit board (PCB) connections to DRAM memory contain memory access resources such as memory management units (MMUs), level 3 cache memories, memory address translation circuitry, TLBs, etc. In such case, die D[0] might forward Channel Blocks to die D[2] and die D[1] might then forward Channel Block to die D[3], or Channel Blocks could be forwarded from D[0] to D[2] and from D[2] to D[3].

As noted above, Channel Blocks and their associated routing by hardware can be allocated to users or tenants. In addition, in example embodiments each Channel Block can support a variable number of virtual channels. Typically, channels within a CBLOCK are restricted to a tenant for security, since channels within a CBLOCK fault together. They may be used for different sessions/applications by the same tenant. Mechanisms are provided to guarantee QoS between Channel Block streams. As the data generators are streaming data records to different channels, QoS and security separation is provided between tenants, and such separation also enables bandwidth guarantees for each separate data stream for each separate client.

To enable such functionality in example embodiments, metadata such as routing information is transmitted along with the data records from the data generators to the PMA 400. That metadata is looked up at various points in the hardware to create separation within the hardware of what kind of interconnect should be used and how well that interconnect is used. Such metadata enables multiple clients running concurrently and potentially asynchronously with each other for a given tenant, which is then scaled across multiple tenants, in a single die or across multiple dies.

### Channel Block Routing

In particular, example embodiments provide multiple Channel Blocks each of which have plural channels. Routers connect from data generators to PMA via crossbars 403, 404 (for FBPs & GPCs), and DirectConnect (for SYS). As shown in the table below, each Channel Block has a unique MMU-recognized ID it uses to stream to the memory management unit and thus to virtual memory (i.e., one CBLOCK has multiple channels that share an MMU Engine ID):

| Die | CBLOCK | Channel | MMU Engine ID |
|---|---|---|---|
| Die0 | Block0 | CH0 | NV_PERF[0] |
| Die0 | Block0 | CH1 | |
| Die0 | Block1 | CH0 | NV_PERF[1] |
| Die0 | Block1 | CH1 | |
| . . . | . . . | . . . | . . . |
| Die1 | Block0 | CH0 | NV_PERF[N] |
| Die1 | Block0 | CH1 | |
| Die1 | Block1 | CH0 | NV_PERF[N + 1] |
| Die1 | Block1 | CH1 | |
| . . . | . . . | . . . | . . . |

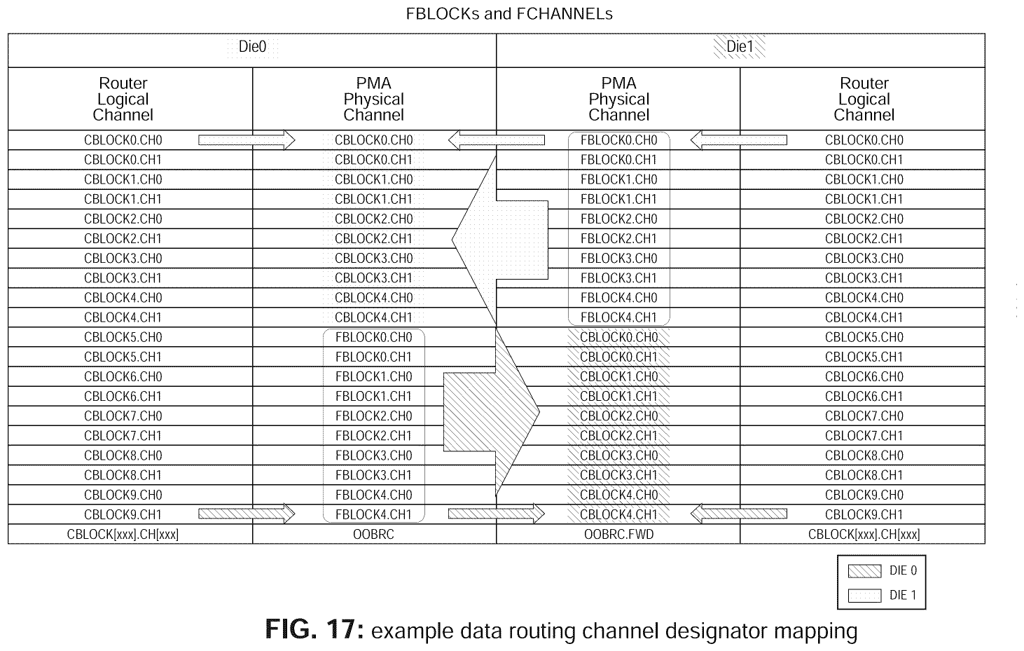

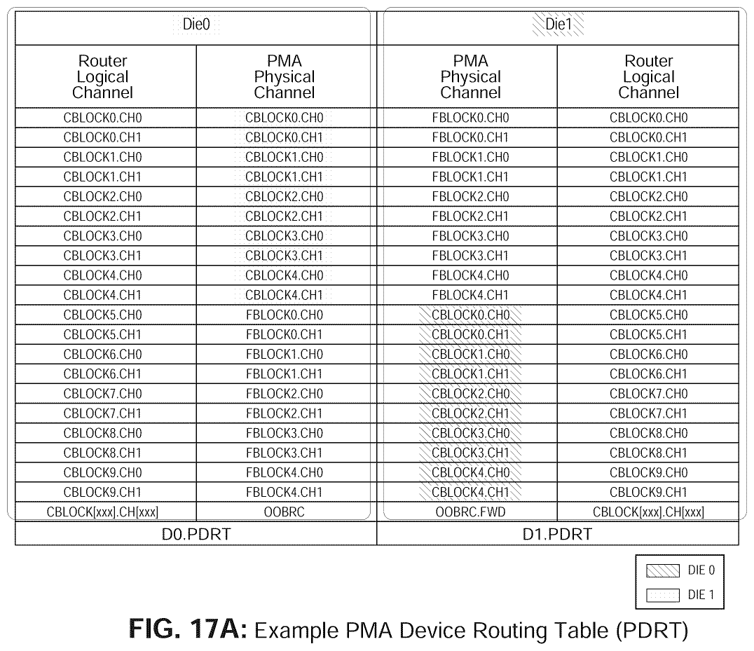

FIG. 17 shows how the PMA router described above determines which router logical channels are sent to local die Channel Blocks and which router logical channels are sent via Forwarding Channel Blocks (“FBLOCKs”) to remote die Channel Blocks. Note that the mapping ensures that distinct channels on the remote die are forwarded to distinct channels on the local die through virtualized FBLOCK cross-die transport. Such routing information may be defined in the PMA device routing table (“P-DRT”) such as shown in FIG. 17A and programmed into the PMA (as noted above, the MMU Engine ID can also be carried via metadata for example for binding to the MMU and virtual memory address spaces.

In example embodiments, the routers are agnostic of the location of the PMAs 400.

In example embodiments, each PMA 400 contains a unit or circuit called PMA Device Routing Table (PDRT) that determines the destination (CBLOCK, CHANNEL) of any PMMRecord and forwards it to the (an)other die using corresponding forwarding channels present on the local die. FIG. 14 is an example block diagram of a single PMA 400 Channel Block functional unit/circuit that manages the memory space transactions for writing data records to memory. As FIG. 14 shows, each PMA 400 can contain any number of such Channel Blocks that can operate concurrently and independently.

To write data to memory, the Channel Block sends a message to the GPU's MMU (memory management unit) advertising itself as a specific profiler engine that wants to write to memory and further specifying its page table pointers described in an instance block data structure. The MMU will then translate any transaction the Channel Block sends according to those page table pointers. As shown in prior art FIG. 3B, prior NVIDIA architectures had a single bind point controller (“BPC”) for sending non-channelized Channel messages. That circuit provided CBLOCK address space” containing multiple virtualized channel buffers, so that the system could collect as much data as needed and perform a burst packet transmission to minimize transmission overhead. Mechanisms were also provided to flexibly manage the output buffers and to track number of sent packets. Example embodiments herein use an enhanced Channel Block architecture shown in FIG. 14 that “channelizes” the Channel Block transmissions (e.g., multiple independent streaming channels to a given virtual memory segment) and arbitrates between channels of a Channel Block and between multiple Channel Block streams (which may originate on the local die or on the remote die) to provide QoS between different channels and between different Channel Blocks. This provides support for multiple channels so different clients (e.g., of the same tenant) can receive different channels. See FIG. 14A. A bind point controller continues to be used, and mechanisms are provided to provide independent control of different Channel Blocks and to provide fault information to the appropriate client. An advantage of using CBLOCK architecture is decoupling MMUENGINEID (memory management unit engine identifier) requirement with channels, since channels within a CBLOCK share the MMUENGINEID. For example, a user that wishes to run profiling, event-trace and monitoring applications simultaneously can do so, since these channels will belong in the same CBLOCK that consumes only one ENGINE-ID in example embodiments. This architecture allows each tenant to define (via secure system software) its virtual address space using the bind point controller, and create multiple independent channels within that virtual address space which are separate from the data generators' point of view in terms of quality of service. The data generators can then work independently to stream their respective records into separate buffers in the virtual memory.

The separation between Channel Blocks and between different channels of a Channel Block means that bandwidth can be flexibly allocated to each of these to provide QoS for each (see discussion below). Further concerning QoS, the example embodiments provide multiple levels of arbitration across all shared data paths (e.g., routers, hubs, the PMA) that are used to stream data records produced by a data generator to the memory:
a first arbitration level may arbitrate between different streams at the data generator;
a second arbitration level may arbitrate between different channels of a Channel Block for different clients of the same user; and
a third arbitration level may arbitrate between different Channel Blocks which can be used to stream data records to different users/virtual memory address spaces.

Such multiple arbitration levels allow example embodiment to maintain the QoS between different users and between different clients of the same user.

In the example shown, the bind point controller BPC is the common section of the virtual address space handler for both virtual channels of the Channel Block. In this example, the channels are per client and are scaleably replicated based on the number of clients that need to be supported for each user. In the example embodiment, the BPC maintains Channel Block-specific page tables to control the bind operation of each virtual channel with the MMU; the MMU does the actual virtual address lookup in example embodiments to determine which virtual machine's virtual memory address the write is directed to. In example embodiments, the BPC is responsible for managing the MMU ENGINE-ID bind/unbind process for a Channel Block and communicating the BIND state to its constituent channels. State information keeps track of the bind state (e.g., bound, unbound, faulted) of the Channel Block and the BPC broadcasts this state to all of the channels. The BPC can also report activity status such as:
EMPTY: The BPC is in UNBOUND/BOUND state without any transactions in flight.
QUIESCENT: The BPC is waiting for bind-ack.
STALLED: BIND transaction is stalled due to arbiter/credits.
ERROR: Either or both channels have faulted.

In general, channels within a Channel Block should get QoS guarantees as per specifications. In example embodiments, the profiling and event channels in a Channel Block are specified to have equal bandwidth sharing. But in future, it is possible that event channels may be specified to have a simply higher priority, or a weighted round-robin priority over profiling channels, depending on the client requirements. As with Channel Blocks, channels within a Channel Block are allowed to be greedy with respect to consuming unused bandwidth. For example, even though channels 0 and 1 in Channel Block-0 are guaranteed equitable distribution of bandwidth, if channel-0 is not able to saturate its share, then channel-1 in Channel Block-0 may consume the channel-0's unused share.

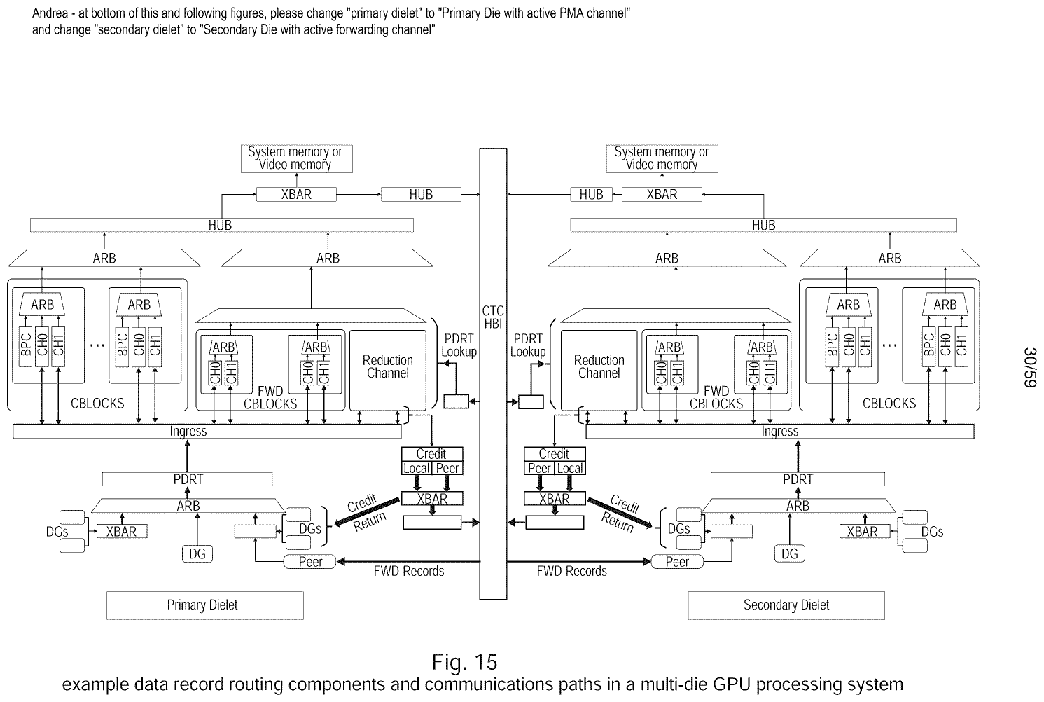

FIG. 15 shows the overall datapath for cross die PMM record streaming (both D0=>D1, and D1=>D0). In example embodiments, there is a router that is responsible for sending data from the data generators to the PMA. Every telemetry record produced by the data generators is routed to this router. The router has separate control mechanisms for each of the channels. PMA device routing table (PDRT) selectively routes the data streams destined to remote channels using a virtualized Forwarding Cblocks (FBLOCKs) for cross-die communication.

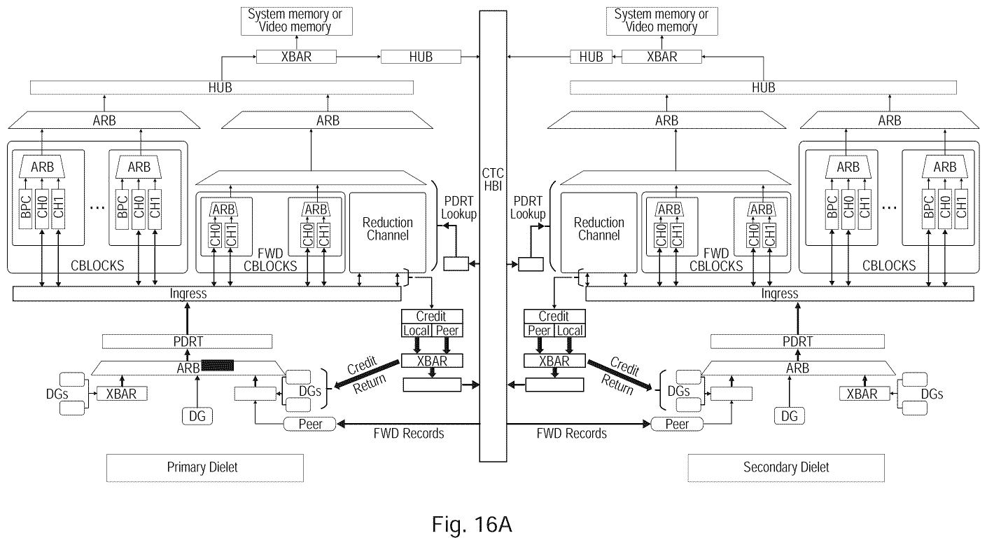

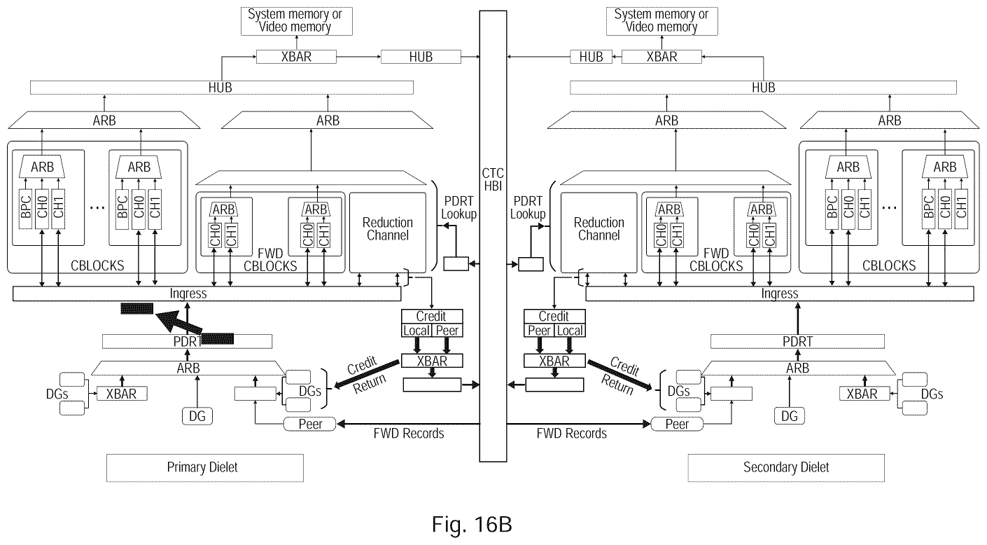

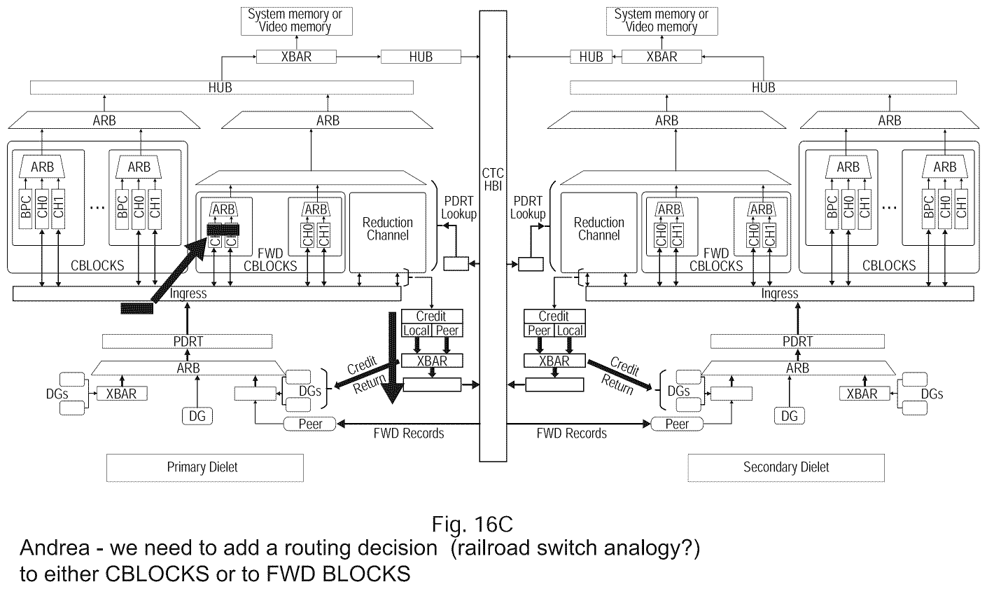

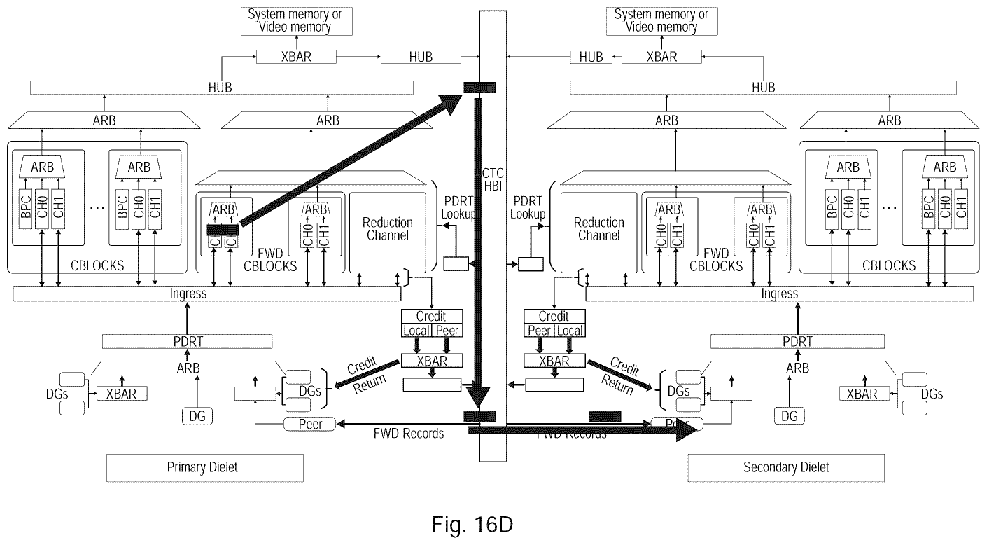

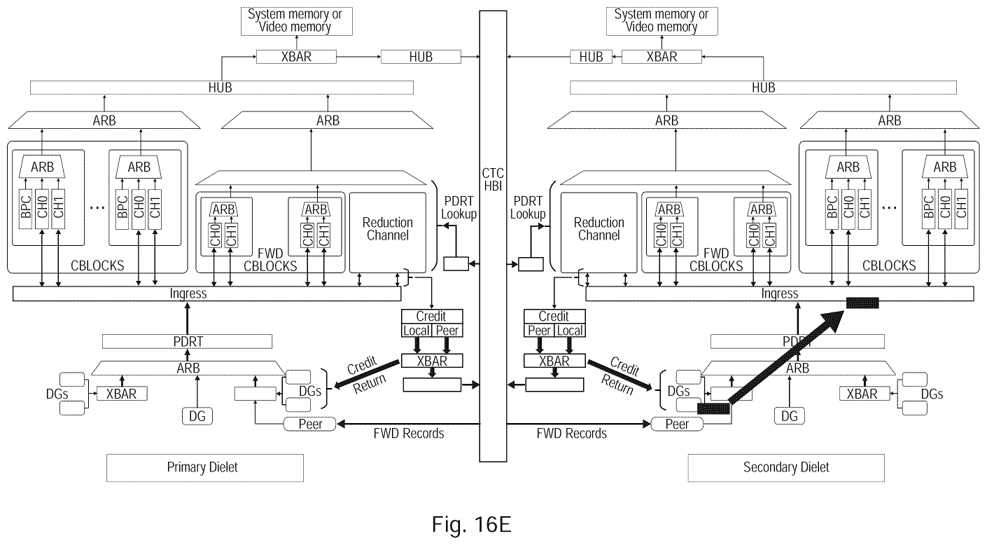

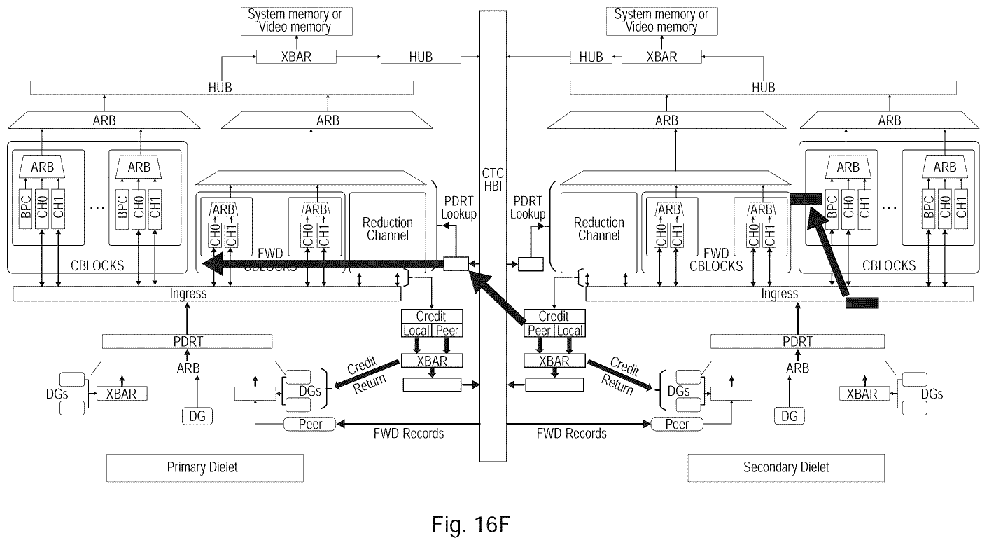

FIGS. 16A, 16B, 16C, 16D, 16E & 16F are together a flip chart animation showing such cross die streaming, i.e., how data originating on a die D[0] may be transported from the die D[0] user interface arbiter through the die D[0] PMA routing table (“PDRT”), a die D[0] ingress FIFO, and forwarded Channel Blocks to the die-to-die high speed interface into the die D[1] unit interface arbiter, die D[1] PMA device routing table and die D[1] ingress FIFO and finally into die D[1]'s (non-forwarded) Channel Blocks for streaming to virtual memory as described above. Thus, in one example design, DGs first stream telemetry records to local PMA. When a telemetry record arrives in the die-local PMA, its associated LocusID={CBLOCK, CHANNEL} is looked up in PDRT to determine where the record is to be routed, e.g., to the left (CBLOCKS) of a local streaming channel or to the right (FWD CBLOCKS) for a remote streaming channel on another die. If the {CBLOCK, CHANNEL} for the record is local on the die, the data record is directed to the appropriate die-local {CBLOCK, CHANNEL}. On the other hand, if the appropriate {CBLOCK, CHANNEL} is operational instead on another (remote) die, then the PDRT routes the telemetry record to the proxy Forwarding Channel Block/Forwarding Channel {FBLOCK, FCHANNEL} associated with the remote Channel Block/Channel{CBLOCK, CHANNEL} so it can be routed to the remote streaming channel on another die. In example embodiments, a Forwarding Channel thus defines a routing mechanism to move data records designated for a remote channel. The Forwarding Channel Block/Forwarding Channel {FBLOCK, FCHANNEL} uses die-to-die interconnects to forward the telemetry record to the target die's PMA. On arrival in the target die's PMA, the target die's PDRT is again looked up and this time the telemetry record is sent to destination, now die-local, Channel Block/Channel {CBLOCK, CHANNEL}.

Example embodiments of the described data record routing mechanism further support a system where the DGs for supported tenants may be spread across multiple dies. It further supports multiple PMAs spread across dies, each containing multiple Channel Blocks, with each Channel Block containing more than one channel. In such embodiments, “forwarding” is used to ensure that telemetry records from any DG, in any die, can be routed to the DG's programmed LocusID={CBLOCK, CHANNEL} irrespective of whether the {CBLOCK, CHANNEL} is local to the die or present on a remote die. The forwarding of telemetry records is done in hardware and is fully transparent to user-software. Software abstractions remain; for example, there may still be a single-ring buffer per tenant which contains telemetry records from DGs associated with the tenant. Clients are unaware whether the DGs are present in the local or remote die. It also minimizes usage of memory management resources such as active TLB lines or flushes as only a single ring-buffer needs to be managed per tenant.

To provide QoS and security in this multi-die design, the single-die, multi-level fairness and QoS is extended to all die-to-die boundaries of the design.

QOS and Fairness: In example embodiments, all records are first routed to the local PMA along die-local datapaths. Hence, fairness and hardware isolation up to the die-local PMA remains identical to single-die design. To provide fairness between die-to-die telemetry record streams, example embodiments provide a two-level arbitration scheme between Forwarding Channels of a Forwarding Channel Block, and between Forwarding Channel Blocks. QoS per die-to-die forwarding path between a Forwarding Channel Block/Forwarding Channel and a Channel Block/Channel {FBLOCK, FCHANNEL}<=>{CBLOCK, CHANNEL} is provided through separate die-to-die credit pools independent of die-local credit pools as discussed below. In a multi-die chip, separate credit pools (discussed below) can allow separate QoS requirements to be provided depending on the die-to-die interconnect used.

Example embodiments are scalable across multiple Channel Blocks, multiple CHANNELS, multiple dies, and agnostic of where the Channel Blocks are located in a multi-die chip. Forwarding Channel Blocks (FBLOCKs) and PDRTs are the only components of some example embodiments that are die-aware. These components are visible only to secure software components. This further strengthens the security and software abstraction as the multi-die nature of underlying chip is abstracted away from all user level telemetry tools. For Reduction Channels (RCs) which perform telemetry record aggregation in hardware, telemetry records are forwarded from all dies to the on-chip device aggregator. Hence, software abstraction for CSP tools remains the same.

### Potential Future Use-Cases Demonstrating Extensibility and Customizability:

The combination of Channel Blocks, Channels, Forwarding Channel Blocks, Forwarding Channels, and PDRT allows example embodiments to be customized for any given multi-die architecture. A few examples are outlined below:

1. Multi-die system consisting of homogenous replicated dielets: For this architecture, logical Channel Blocks for supporting maximum number of concurrent tenants are created of physical Channel Blocks in each die. For example, with N Channel Blocks per PMA, the die-0 and die-1 can represent logical Channel Blocks 0 to (N−1) and N to (2N−1), respectively. The PDRT of each die encodes the logical {CBLOCK, CHANNEL} to physical {DIEID, CBLOCK, CHANNEL} mapping.

2. Multi-die system consisting of ‘N’SOC(s) containing CPU (Central Processing Unit) cores <->‘M’fractional GPUs: A tenant can own certain number of CPU cores across multiple SOC (System on Chip) dies and a fractional GPU consisting of hardware resources obtained from multiple GPU dies. In this case, telemetry records from multiple CPU cores and GPU dies can be collected locally and then forwarded to appropriate CHANNEL that manages the buffer for the given client.

3. As noted above in connection with FIG. 13B, multi-die system consisting of dielets lacking memory management hardware: The architecture here consists of dielets which lack memory management hardware and dielets which contain memory management hardware. For dielets lacking memory management hardware, their local PMA contains only Forwarding Channels and the PDRT is programmed to redirect all telemetry records to the dies containing the Channels.

4. Multi-chip package: Given appropriate latency, bandwidth, or security requirements, example embodiments can be extended to multi-chip packages where other dynamic, packet-based interconnects like NVLINK can also be utilized.

### Data Communications Examples:

Consider die D0 trying to send PMM records to logical CBLOCK 5, channel 0 (i.e., physical D1.CBLOCK[0].CHANNEL[0]). The datapath would be D0.DG->D0.PMA->D0.FWD_CBLOCK[0].FCHANNEL[0]->D0.CTC-MI (CTC-MI==Chip2Chip messaging interface)->D1.CTC-MI->D1.PMA->D1.CBLOCK[0].CHANNEL[0](or logical CBLOCK[5].CHANNEL[0].

Similar flow can also be done in reverse direction for die D1 trying to send PMM records to logical CBLOCK 0, channel 0 (i.e., physical D0.CBLOCK[0].CHANNEL[0]). The datapath would be D1.DG->D1.PMA->D1.FWD_CBLOCK[0].FCHANNEL[0]->-D1.CTC-MI (CTC-MI==Chip2Chip messaging interface)->D0.CTC-MI->D0.PMA->D0.CBLOCK[0].CHANNEL[0](or logical CBLOCK[0].CHANNEL[0].

### Example Separate Credit System For Data Communications

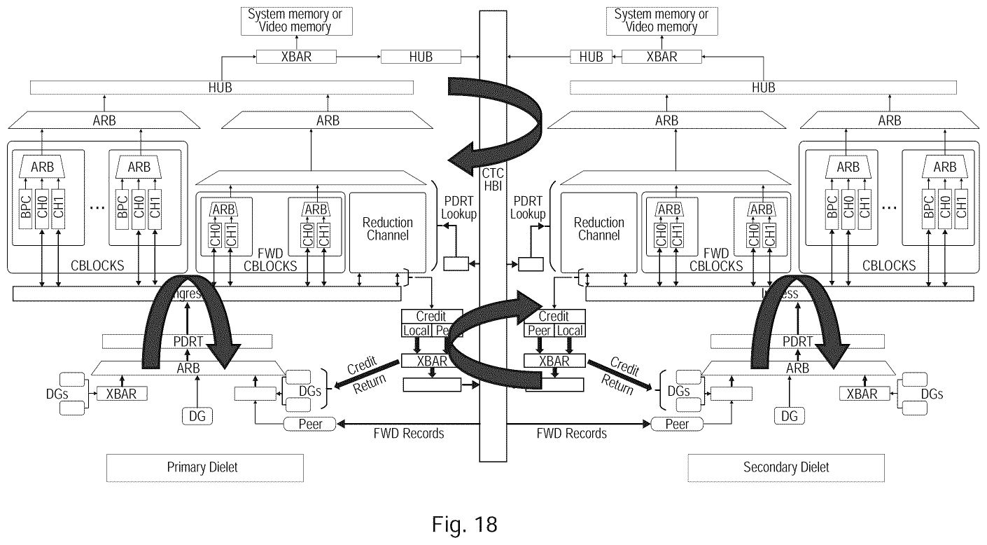

To further shore up QoS mechanisms, FIG. 18 shows separation between die-to-die interconnects. For example, shadow buffers can be used to dynamically absorb backpressure in the die-to-die interconnections if needed. QoS per die-to-die forwarding path between a Forwarding Channel Block/Forwarding Channel and a Channel Block/Channel {FBLOCK, FCHANNEL}<=>{CBLOCK, CHANNEL} is provided through separate die-to-die credit pools independent of die-local credit pools. As indicated by the curved arrows of FIG. 18, separate credit pools are used to ensure QoS independently of local die streaming. As die crossing involves crossing CTCHBI, the datapaths in one example embodiment consists of two credit loops, a) a local credit loop optimized for die-local streaming, and b) a PMA<->PMA credit loop designed to support cross-die streaming bandwidth while absorbing a delay of a single retrain+replay events.

### Example Data Status Rollup

Example embodiments also have a mechanism to separate data signals over a shared data path. Meanwhile, clients are coming up at various times for the same or different tenants. When it is time to shut down a particular data reporting operation for a particular client and/or tenant, the system commands the data generators to stop counting. Information indicating the signals are no longer valid is then propagated over the data paths and through the arbiters and routers to flush the data to the PMA, such that the PMA can flush the data out to memory. Example embodiments provide idle status flags along the data path that software can poll as it is shutting down the system.

At the same time, the data generators can be dynamically allocated to any channel. Unless dynamic mapping information is propagated between the data generator and the channel, there is no way to tell whether the channel has been completely flushed of data. Example embodiments therefore provide a mechanism for propagating dynamic mapping information for every channel outwards from the data generators through the PMAs. Example embodiments provide a config record mapping written by software that indicates associations between data generators, users/tenants and assigned Channel Block channels:

| FIELD | Usage | |
|---|---|---|
| 1 | DG_ID | unique identifier for data generators in a |
| | | chiplet |
| 2 | MAPPED | map or unmap a data generator |
| 3 | DG_CHANNEL_ID | intended channel id for data generator if |
| | | MAPPED = 1 |

An additional complexity in example embodiments is that the same data generator can be shared by more than one channel (although in one embodiment a DG is mapped to only one channel at a time) since the example embodiment provides flexibility to map any data generator to any channel, regardless of physical location.

This mapping information is propagated along the shared data path to indicate the dynamic mapping of data generators to Channel Block channels. The propagated association information is used to populate routing tables along the shared data path.

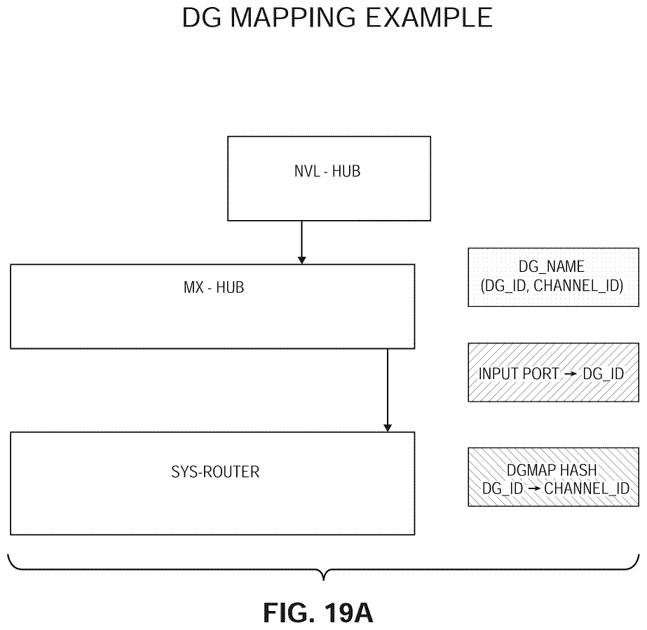

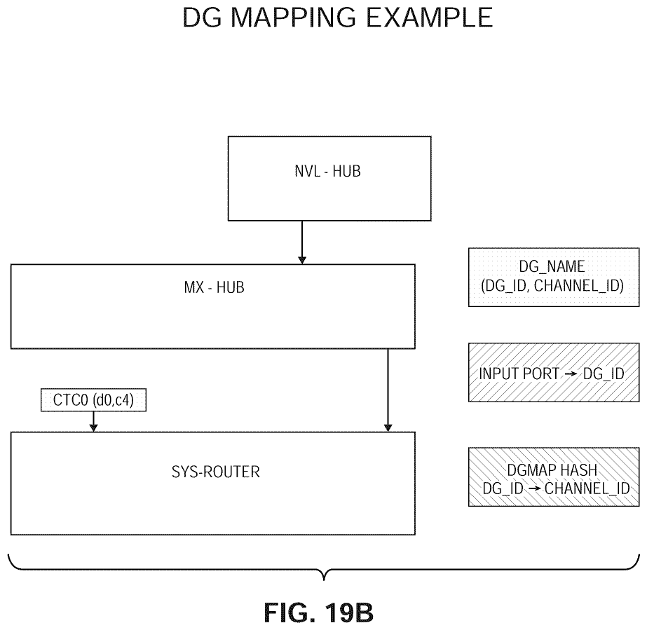

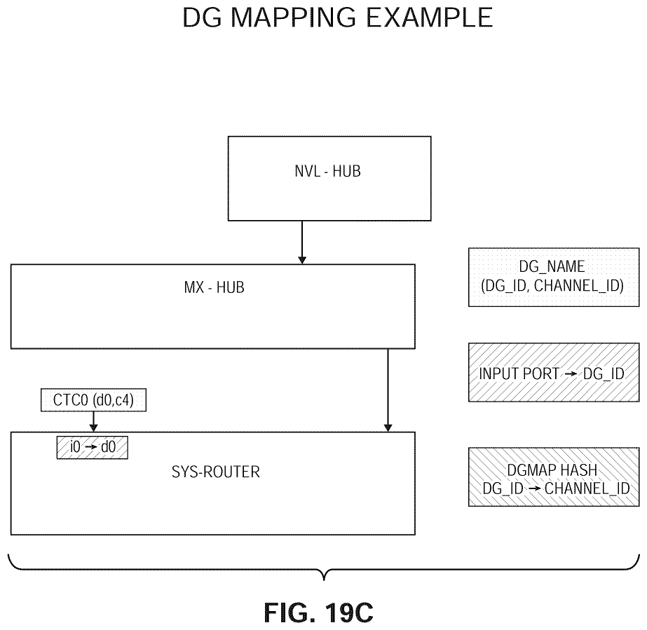

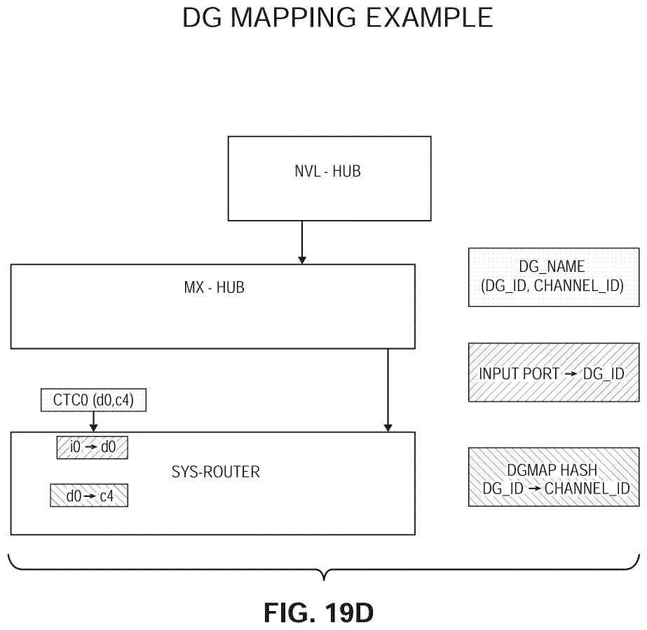

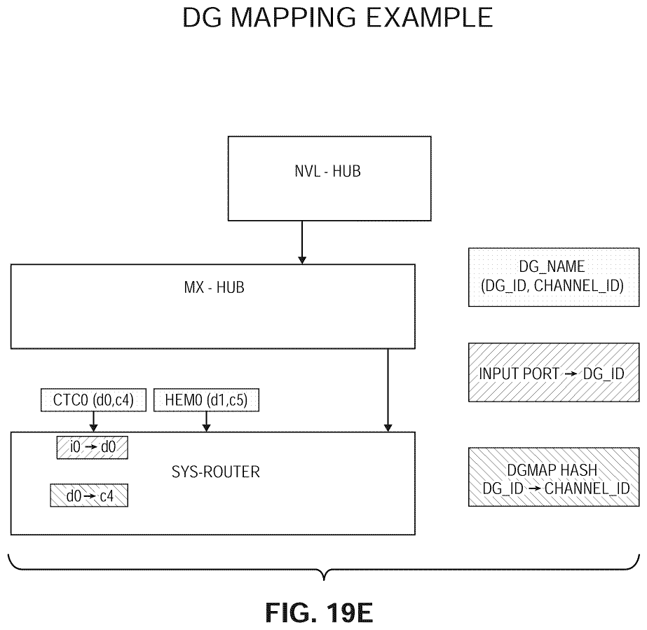

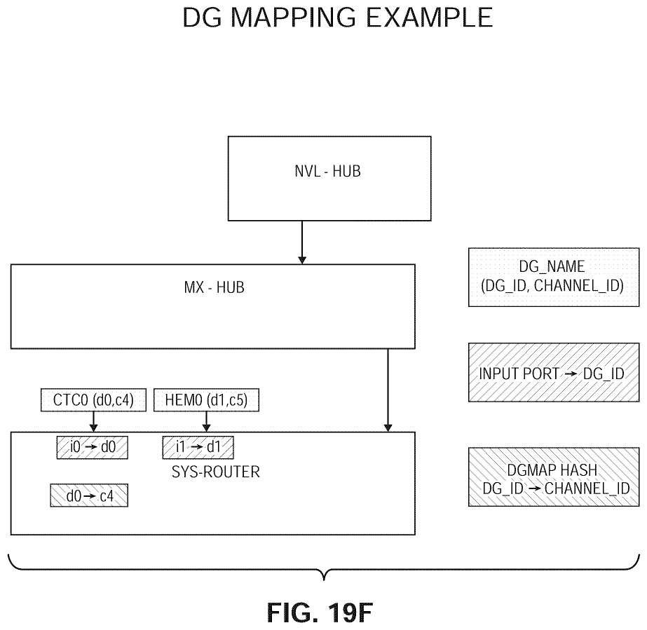

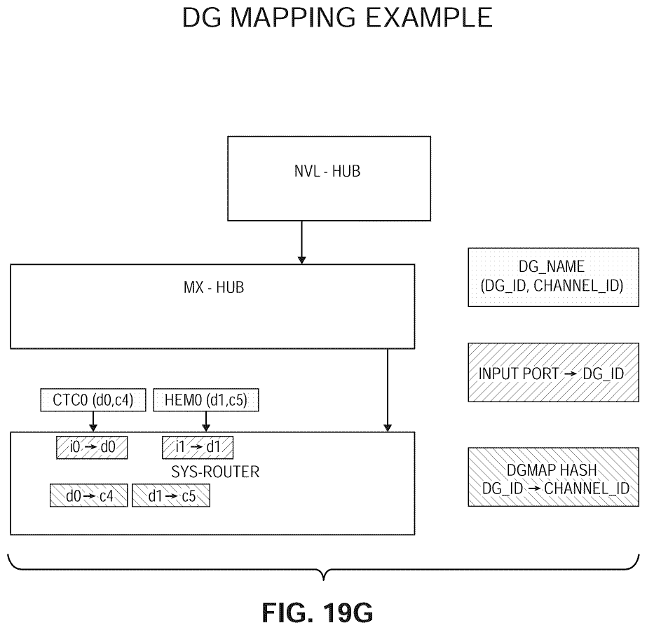

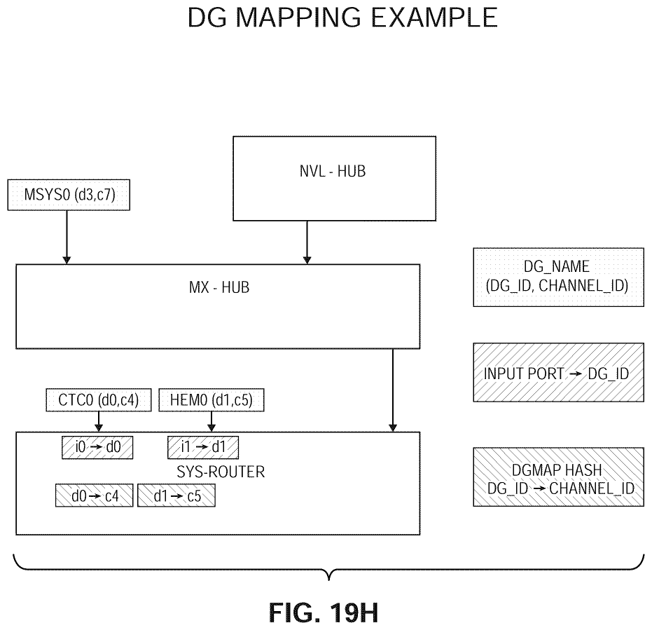

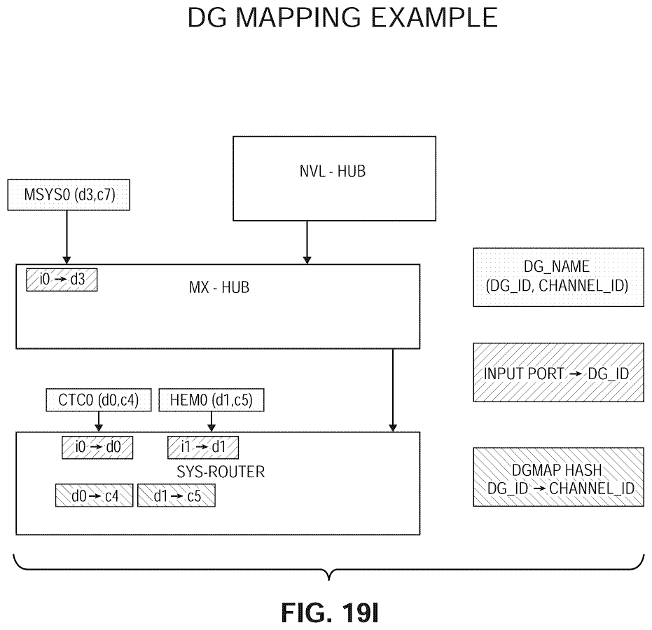

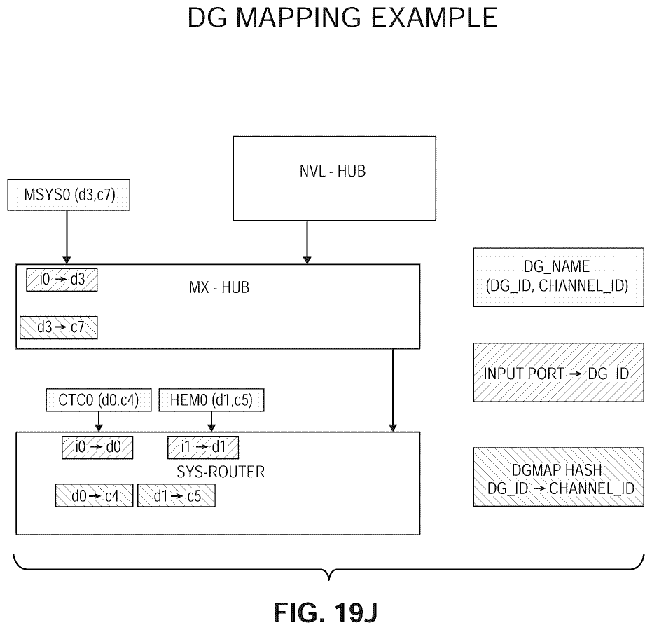

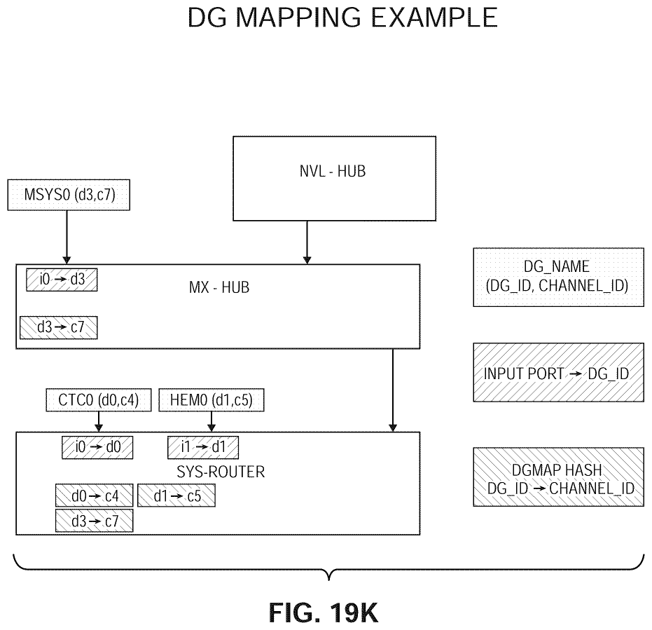

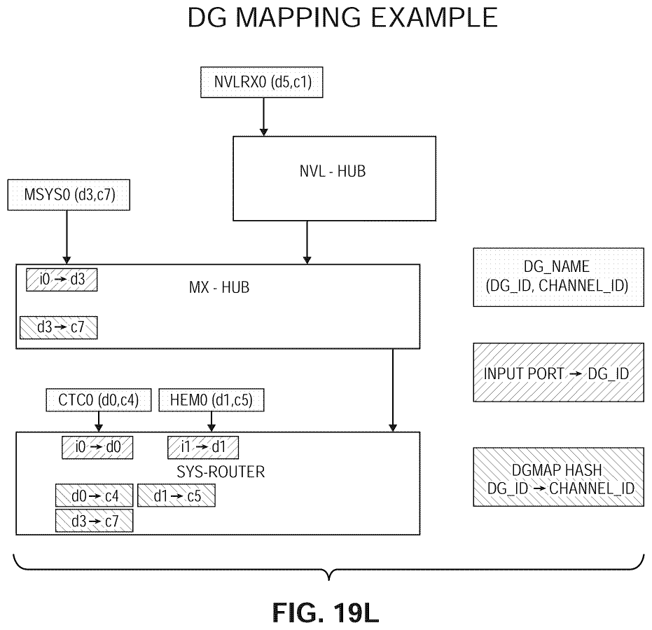

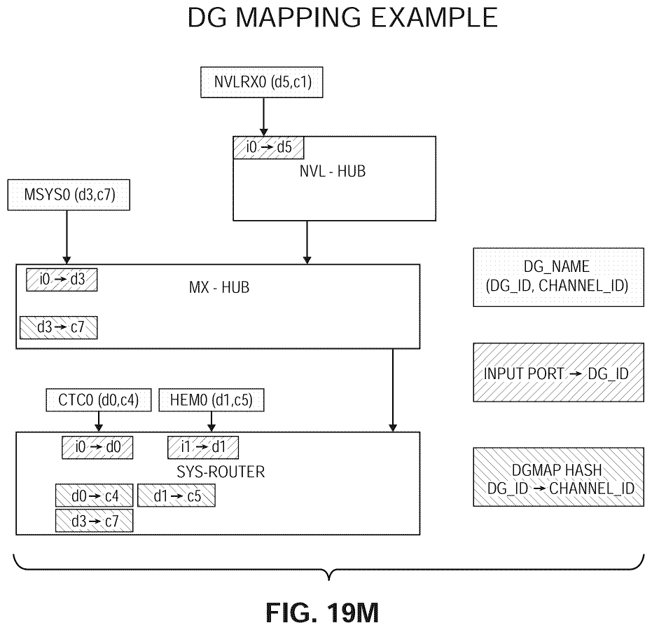

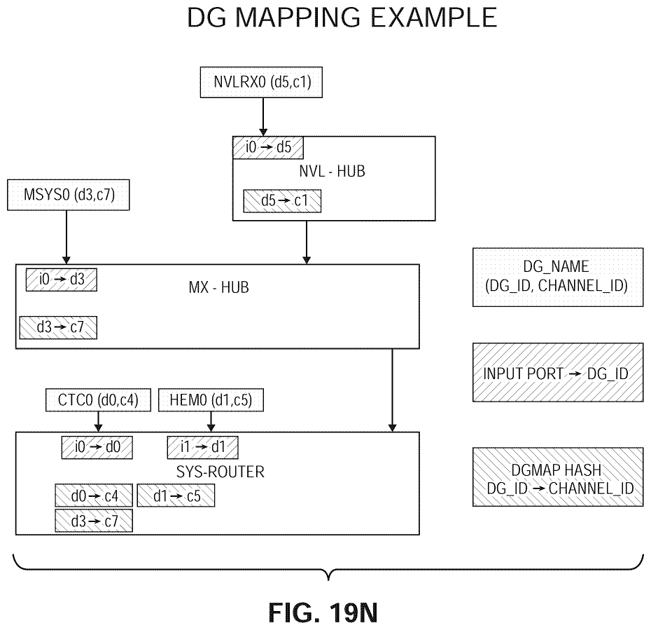

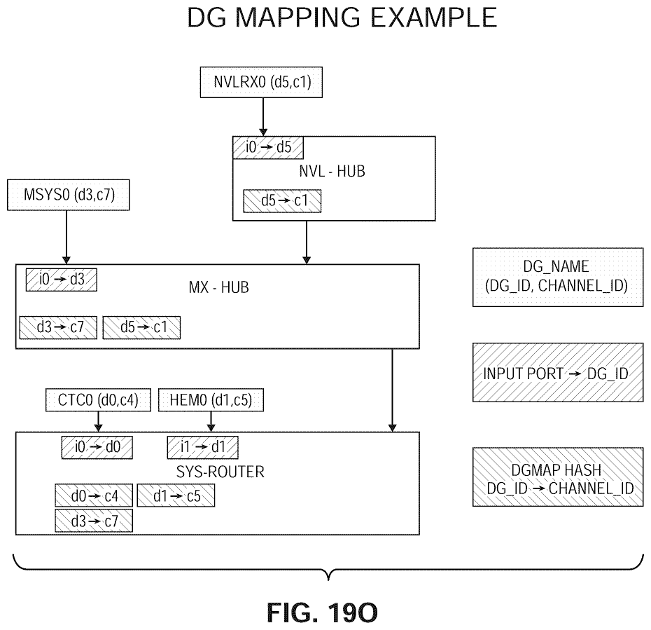

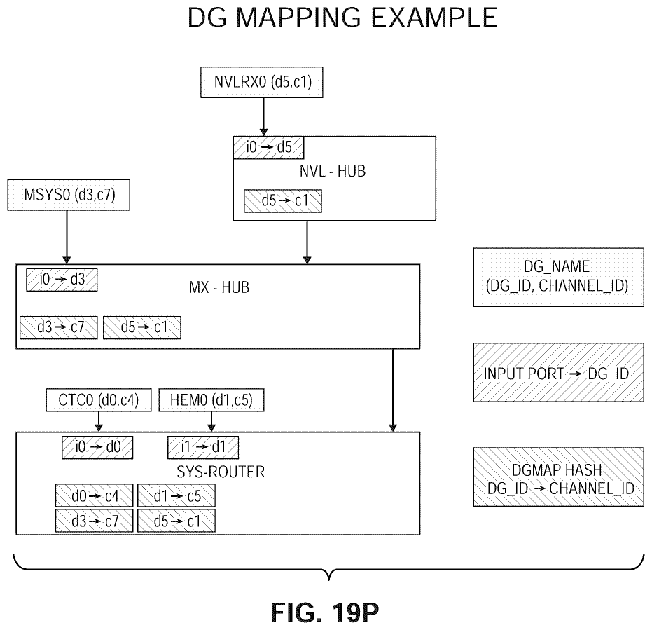

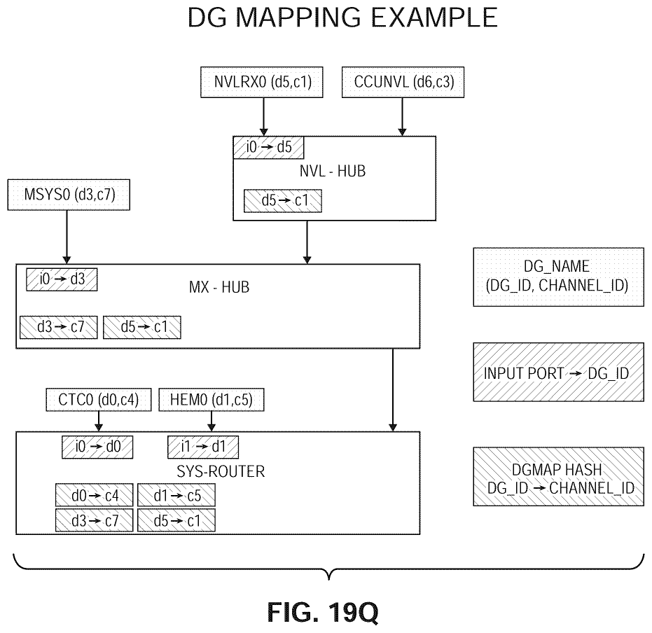

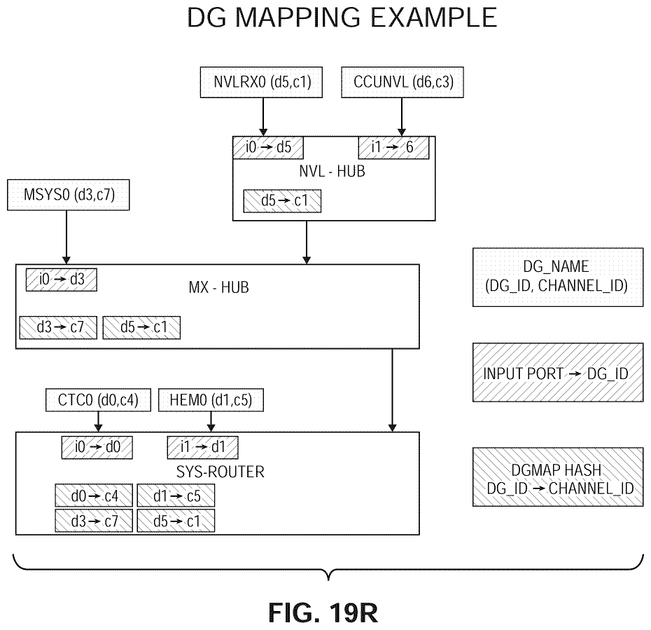

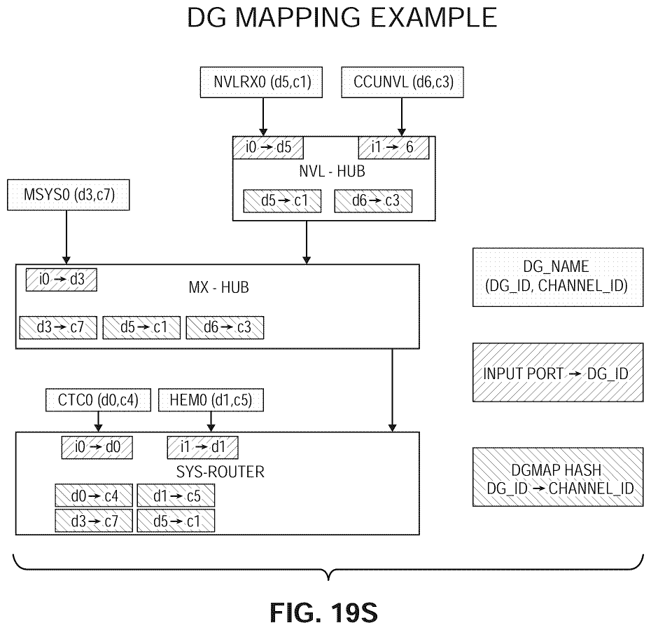

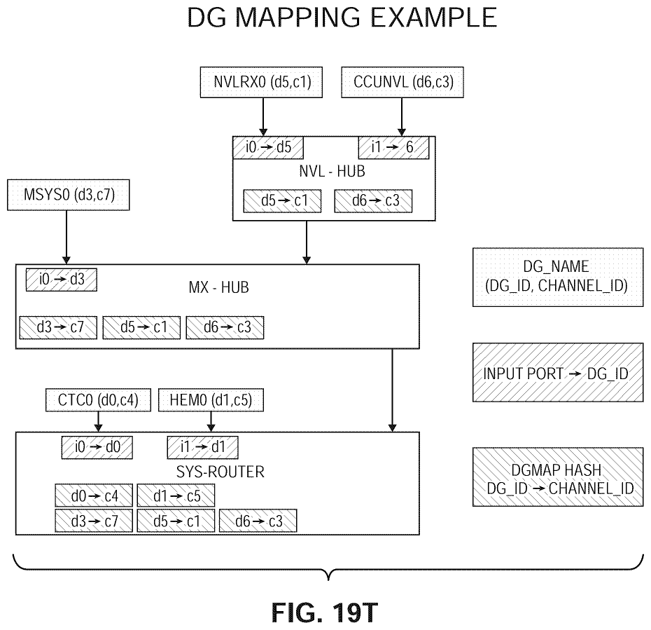

FIG. 19A, 19B, 19C, 19D, 19E, 19F, 19G, 19H, 19I, 19J, 19K, 19L, 19M, 19N, 190, 19P, 19Q, 19R, 19S, 19T together are a flip chart animation showing how idleness status information can be propagated along a data path. FIG. 19A shows a system router collecting telemetry data each stream of which has a unique physical data port identifier and a logical channel association, e.g., “CTC0(d0, c4)”. Records of this physical-port-to-logical-channel mapping are stored in the system router (FIG. 19B, 19C, 19D). The same happens with other data generator port (“HEM0 (d1, c5). See FIGS. 19E, 19F, 19G. A port association (“MSYS0(d3, c7) is then created at the MX-HUB (FIG. 19H, 19I, 19J) associated with a corresponding logical channel. This new association is then advertised to the data path (FIG. 19K) so the system router knows about it by propagating the association upstream in the data path to the next upstream router. Similarly, a new port to channel association (“NVLRX0(d5,c1)” is created at the routing level NVL-HUB (FIGS. 19L, 19M, 19N). This new association is propagated upstream to inform the MX-HUB routing level (FIG. 190) and the system router level (FIG. 19P). See similar propagation for yet another new association (FIGS. 19Q, 19R, 19S, 19T).

In example embodiments, the association information may be translated as it is passed upstream along the data channel in order to make it relevant to the components receiving the status information. For example, when the association information reaches the NVLink Hub level, the association information is merged to a channel level association. In this way, tables can be dynamically published along the data path to coalesce and propagate information about idleness upstream, and each router along the data path offers a point of contact for data rollup. Because the [INPUT->DG_ID->CHANNEL_ID] mapping shown can be used by the routers to merge the data generator's status into a channel's status, each router can be polled for the DG/channel status directly to provide merged DG status per channel—there is no requirement to start at the data generator or other point downstream in the data path.

### Exemplary Computing System Contexts and Use Cases

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

The techniques disclosed herein may be incorporated for example in any processor that may be used for processing a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, consistent with security considerations, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA GeForce Now (GFN), and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

All patents, patent applications and publications cited herein are incorporated by reference for all purposes as if expressly set forth.

Those skilled in the art will recognize that while example preferred embodiments disclosed herein provide “telemetry” of “performance monitoring” data within a “graphics processing unit”, aspects of the technology herein are not limited to “telemetry” or “performance monitoring” or “graphics processing units” but rather could be used to generate, command, collect and transport any type of data within any type of processing system using any type of data transport.

It should be noted that techniques such as using Channel Blocks as described above is applicable to a single-die system as well as to a multi-die system, and that the design of a general multi-die telemetry system does not require, but also does not preclude, the Channel Block arrangement. Such features can be considered independent of other features specific to multi-die architectures, depending on chip configuration.

Additionally, while example embodiments provide communications and distributed functionality across any number of dies (including a single die) disposed within the same package, they could also provide communications and distributed functionality across any number of dies (including a single die) within different packages, consistent with latency requirements.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A graphics processor comprising:
a first semiconductor die including a first control path circuit or processor that determines a first monitoring parameter and sends a forwarding command packet indicating the first monitoring parameter to a second semiconductor die; and
the second semiconductor die including a second control path circuit or processor that determines a second monitoring parameter and determines a global monitoring parameter in response to the forwarding command packet and the determined second monitoring parameter.

2. The graphics processor of claim 1 wherein the first and second monitoring parameters are each temporal.

3. A method comprising:
determining a first temporal region of interest local to a first semiconductor die;
determining a second temporal region of interest local to a second semiconductor die;
forwarding information indicating the first temporal region of interest from the first semiconductor die to the second semiconductor die; and
determining a global temporal region of interest in response to the forwarded information and the determined second temporal region of interest.

4. The method of claim 3 wherein determining the first temporal region of interest is based on an engine start command and an engine stop command, the engine disposed on the first semiconductor die.

5. The method of claim 4 wherein determining the first temporal region of interest is also based on a further engine start command and a further engine stop command, the further engine also disposed on the first semiconductor die.

6. The method of claim 5 wherein determining the first temporal region of interest comprises selecting the first temporal region of interest relative to the engine start command, the engine stop command, the further engine start command and the further engine stop command.

7. The method of claim 6 wherein selecting comprises defining the global temporal region of interest between a first start command from any engine and a last stop command from any engine.

8. The method of claim 6 wherein selecting comprises defining the global temporal region of interest between a first start command from any engine and a first stop command from any engine.

9. The method of claim 3 wherein determining the global temporal region of interest comprises selecting the global temporal region of interest relative to the first temporal region of interest and the second temporal region of interest.

10. The method of claim 3 further including triggering to snapshot performance data or propagating command and control information to a first data generator on the first semiconductor die during the global temporal region of interest, and triggering to snapshot performance data or propagating command and control information to a second data generator on the second semiconductor die during the global temporal region of interest.

11. The method of claim 10 wherein at least one of the first data generator and the second data generator comprises a performance data monitor.

12. A processing system comprising:
a first semiconductor die including a first control path circuit or processor that determines a first temporal region of interest local to the first die and forwards information indicating the first temporal region of interest to a second semiconductor die; and
the second semiconductor die including a second control path circuit or processor that determines a second temporal region of interest local to the second semiconductor die and determines a global temporal region of interest in response to the forwarded information and the determined second temporal region of interest.

13. The processing system of claim 12 wherein the first control path circuit or processor determines the first temporal region of interest based on an engine start command and an engine stop command, the engine disposed on the first semiconductor die.

14. The processing system of claim 13 wherein the first control path circuit or processor determines the first temporal region of interest also based on a further engine start command and a further engine stop command, the further engine also disposed on the first semiconductor die.

15. The processing system of claim 13 wherein the first control path circuit or processor determines the first temporal region of interest by selecting the first temporal region of interest relative to the engine start command, the engine stop command, the further engine start command and the further engine stop command.

16. The processing system of claim 15 wherein selecting comprises defining the global temporal region of interest between a first start command from any engine and a last stop command from any engine.

17. The processing system of claim 15 wherein selecting comprises defining the global temporal region of interest between a first start command from any engine and a first stop command from any engine.

18. The processing system of claim 12 wherein the second control path circuit or processor selects the global temporal region of interest relative to the first temporal region of interest and the second temporal region of interest.

19. The processing system of claim 12 further including a first trigger that triggers a first data generator on the first semiconductor die to monitor a first engine on the first semiconductor die during the global temporal region of interest, and a second trigger that triggers a second data generator on the second semiconductor die to monitor a second engine on the second semiconductor die during the global temporal region of interest.

20. The processing system of claim 19 wherein at least one of the first data generator and the second data generator comprises a counter, a workload execution timeline data or a performance monitor.

21. A GPU comprising:
a first virtualizer that enables a first tenant to use first fractional parts of a first die and a second die, and enables a second tenant to use second fractional parts of the first die and the second die, wherein at least some of the first fractional parts are distinct from the second fractional parts;
a controller that enables the first tenant to issue first performance monitoring commands for the first fractional parts and enables the second tenant to issue second performance monitoring commands for the second fractional parts; and
communication paths on the first die and the second die that keep the first monitoring commands and the second monitoring commands separate while communicating the first monitoring commands to the first fractional parts on the first die and the second die and communicating the second monitoring commands to the second fractional parts on the first die and the second die.
